(19) United States
(12) Patent Application Publication
(10) Pub. No.: US 2003/0185990 A1
(43) Pub. Date: Oct. 2, 2003

(54) Method for pretreating and coating metal surfaces prior to forming, with a paint-like coating and use of substrates so coated

(76) Inventors: Klaus Bittner, Frankfurt am Main (DE); Heribert Domes, Weilmunster (DE); Christian Jung, Oberhaid (DE); Norbert Maurus, Langen (DE); Thomas Kolberg, Heppenheim (DE); Marcus Schinzel, Eppstein (DE); Hardy Wietzoreck, Frankfurt am Main (DE); Toshiaki Shimakura, Chiba-ken (JP)

Correspondence Address: FULBRIGHT & JAWORSKI, LLP, 666 FIFTH AVE, NEW YORK, NY, 10103-3198, US

(21) Appl. No.: 10/380,579

(22) PCT Filed: Sep. 25, 2001
(86) PCT No.: PCT/EP01/11083

(30) Foreign Application Priority Data
Sep. 25, 2000 (DE) 100 47 686.4
Oct. 11, 2000 (DE) 100 50 532.5
Mar. 6, 2001 (DE) 101 10 830.3
Apr. 21, 2001 (DE) 101 19 606.7
Sep. 20, 2001 (DE) 101 46 446.0

(51) Int. Cl. B05D 3/02; B05D 3/06

(52) U.S. Cl. 427/385.5; 427/256; 427/558

(57) ABSTRACT

The invention relates to a method for coating a metal strip for use in the automotive, aircraft or aerospace industry. The strip or the strip sections produced on the basis thereof in a later step is/are first coated with at least one anticorrosive coating and then with at least one coating of a paint-like polymer-containing coating. The strip, once coated with at least one anticorrosive coating or once coated with at least one coat of a paint-like coating, is divided up in strip sections. Said coated strip sections are then formed, joined and/or coated with at least one (further) paint-like coating and/or coat of paint. The paint-like coating is achieved by coating the surface with an aqueous dispersion that contains, in addition to water, at least one UV-crosslinkable water-soluble and/or water-dispersible resin, at least one wax as the forming additive, at least one photoinitiator, and at least one corrosion inhibitor. The coating is dried and cured once it has been applied to the metal surface, thereby forming a coating that has a thickness of up to 10 μm once cured.

The invention relates to a method for coating metal surfaces as well as the use of the coated substrates produced by the method according to the invention in the automobile sector, in particular in automobile production and for the manufacture of components or body parts or preassembled components in the automotive, aircraft or aerospace industry. The invention relates in particular to new possibilities for the preparation and assembly of vehicles in that, unlike the current procedure, the various body parts no longer have to be assembled, cleaned, phosphated and only then painted with the whole paint system.

There is therefore a need to rationalise even further the production of car bodies and their individual parts, as well as claddings and linings for vehicles and aircraft.

The anti-corrosive coating(s) should together with the paint be able to be easily mechanically formed (shaped) and should also exhibit a good corrosion protection and a good paint adherence after the forming. In addition it may be necessary for these coatings also to be able to be clinched readily after the joining process without thereby suffering from an increased tendency to corrosion.

Similar production methods already exist for producing paint-coated metal sheeting for sheeting precoated in strip form that are used for domestic appliances, architectural metal sheeting and furniture. The requirements that this sheeting has to meet differ significantly however from the requirements in particular in automotive and aircraft construction. The requirements in the automotive, aircraft or aerospace industry as regards the strength of the coated sheets, joining techniques, paint structure and the paint coat properties such as brilliance, gloss, corrosion resistance, scratch resistance, paint adherence and protection against flying stones vary greatly and influence the overall production process. The high-performance properties of these metal sheets must also still be sufficiently high in particular in the region of the formed and joined parts. The same stringent requirements that are nowadays imposed are usually also applied to a changed production process and a changed coating structure even if individual layers are thinner than 4 μm.

The base coat for architectural metal sheeting nowadays often contains chromate on the outside in order to achieve an improved corrosion resistance with a relatively small coat thickness; a cover coat with a thickness in the range from 10 to 20 μm is normally applied to the base coat. The same or similar base coats as on the front side are often applied as a rear side coat with a thickness in the range from 6 to 15 μm as a single paint coat, on the inside of architectural metal sheeting. However, to the best of the applicants' knowledge, UV-cured paints are not yet in use for coating strip material in the domestic appliance and architectural sectors.

The strip production plant used in each case may be a galvanising line, a coil coating line and/or a different type of coating line, such as for example a paint line in for instance an automobile factory, in which cut strip material that has previously been pretreated in a strip production plant is coated with a paint and/or with a paint-like coating.

Pre-phosphating is understood to denote a temporary protection of metal surfaces, in which the substrates coated in this way are then optionally oiled, intermediately stored and formed, and after deoiling can for example be joined by clinching, bonding or welding and/or can be pretreated again with for example phosphate, before the paint system is applied.

The pretreatment before the painting is nowadays performed, especially in the European automobile industry, in some cases without intentional addition of chromium and in other cases with addition of chromium. It is however in principle preferred to operate in a chromium-free or largely chromium-free manner, in particular chromium-free insofar as no chromium is intentionally added, in order to avoid this toxic heavy metal. On the other hand an addition of chromium has a particularly anticorrosive action since it can produce a self-healing effect at a damaged site. Preferably the pretreatment solutions in each case also contain little or no cobalt, copper, nickel and/or other heavy metals. However, contents of nickel in particular are always especially advantageous and are therefore in practice always included for example in phosphating operations. The pretreatment solutions may be applied either in a rinse process or in a no-rinse process. In the rinse process rinsing is performed after the application of the solution—which may be carried out in particular by spraying and/or dipping—with the formation of the pretreatment layer. In the no-rinse process the solution is applied for example with a rollcoater and immediately dried without rinsing.

The term base coat is understood to mean a paint or a paint-like coating that can replace the cathodic dipping paint (CDP; electrodeposition paint) normally used in the production of car bodies. This may be a primer, in particular a lubrication, welding or pretreatment primer, or may be another type of coating, for example based on silane/siloxane. If necessary a paint intermediate coat can be applied between the base coat and the filler (=toner). Normally at least one clear lacquer is applied to the filler, which enhances the brilliance and is also termed top coat.

The coating formed with a lubrication primer can on account of its good slip properties and low friction be particularly effectively and easily formed. A welding primer and the coating produced therefrom thus contains such a high proportion of electrically conducting substance, in particular electrically conducting particles, that it is possible to weld two metal sheets together without significantly increased expenditure even if, in this connection, two paint-like coatings have to be in intimate contact with one another. A pretreatment primer is a primer or a corresponding coating that can also replace the anticorrosive properties of a pretreatment layer. These are all paint-like coatings.

The invention furthermore provides a method for coating metal surfaces as well as the use of the substrates coated in this way.

Methods for coating metal surfaces with an aqueous dispersion that contains, in addition to water, at least one UV-crosslinkable resin and at least one photoinitiator, are known generally. They are used for coating with UV paints or similar UV-curing organic coatings. Such methods are normally provided for coating floor coverings, wooden articles, cork articles, plastics parts, paper, films or packagings, but not for the rapid and anticorrosive coating of for example strip-like metal material at rates of 10 to 250 m/min. It is known that UV curing is in principle extremely suitable for curing coatings on temperature-sensitive substrates without exposing the latter to relatively high temperatures. On the other hand most organic coatings on metal substrates, such as for example sheeting for the metal-processing industry, are coated with solvent-containing paints or with water-based paints, which have to be thermally dried, crosslinked and/or cured. All these aforementioned coatings nowadays normally have coat thicknesses in the range significantly above 20 μm and in some cases significantly above 100 μm. UV curing may in many cases have the advantage that an anticorrosive, resistant organic coating can be applied in a solvent-free manner.

According to the applicants' knowledge, UV-curing organic, sufficiently flexible and at the same time sufficiently anticorrosive coatings have not hitherto been applied to metal strips. There is therefore a need for aqueous dispersions that take account of the altered conditions of use of paint-type compositions that exist in rapid strip coating, and which are not, or for the most part not, cured thermally, but by actinic radiation. Actinic radiation is hereinafter referred to as UV radiation and the crosslinking produced thereby as UV curing.

The object therefore existed of providing processes for the production of parts, in particular for the assembly of car bodies, in which it is possible to carry out a longer part of the production process of the parts, possibly still in the form of strips, than was hitherto the case in a strip line.

The object also existed of providing methods for coating metal substrates that are also suitable for coating rapidly moving strips, by means of which organic, sufficiently flexible and at the same time sufficiently anticorrosive coatings can be applied that permit the production of a base coat and possibly also the subsequent coats. This method should be suitable for economical and as far as possible environmentally friendly industrial application.

This object is achieved by a method for coating a metal strip for the automotive, aircraft or aerospace industry, in which the strip or possibly the strip sections produced therefrom in the subsequent operation is/are first of all coated with at least one anticorrosive coating and then with at least one layer of a paint-like polymer-containing coating, in which the strip after the coating with at least one anticorrosive coating or after the coating with at least one coat of a paint-like coating is divided into strip sections, the coated strip sections then being formed, joined and/or coated with at least one (further) paint-like coating and/or paint coating, wherein the paint-like coating is formed by coating the surface with an aqueous dispersion that contains, in addition to water, at least one UV-crosslinkable water-soluble and/or water-dispersible resin, at least one wax as forming additive, at least one photoinitiator and at least one corrosion inhibitor, wherein the coating is dried and cured after it has been formed on the metal surface, and wherein a coating is formed that when cured has a coat thickness of up to 10 μm and that on a test surface subjected to a mandrel bending test according to DIN ISO 6860—but without cracking the test surface—using a mandrel of 3.2 mm to 38 mm diameter, does not exhibit signs of corrosion of more than 5% in an immediately following condensate water atmosphere test according to DIN 50017 KFW over 240 hours.

This object is also achieved by a method for coating a metal strip for the automotive, aircraft or aerospace industry, in which the strip is first of all coated with at least one coat of a paint-like polymer-containing coating without previously applying an anticorrosive coating, wherein the strip after the coating with at least one coat of a paint-like coating is divided into strip sections, wherein the coated strip sections are then formed, joined and/or coated with at least one (further) coat of a paint or a paint-like coating, wherein the paint-like coating is formed by coating the surface with an aqueous dispersion that contains, in addition to water, at least one UV-crosslinkable water-soluble and/or water-dispersible resin, at least one wax as forming additive, at least one photoinitiator and at least one corrosion inhibitor, wherein the coating is dried and cured after it has been formed on the metal surface, and wherein a coating is formed that when cured has a coat thickness of up to 10 μm and that on a test surface subjected to a mandrel bending test according to DIN ISO 6860—but without cracking the test surface—using a mandrel of 3.2 mm to 38 mm diameter, does not exhibit signs of corrosion of more than 5% in an immediately following condensate water atmosphere test according to DIN 50017 KFW over 240 hours.

The division of the coated metal strip into strip sections may be carried out for example by cutting, pressing and/or punching. The term “anticorrosive coating” within the context of this application denotes a coating that, in addition to having an anticorrosive effect, also has a good adhesion to the respective substrate, is well suited as an adhesion base for the subsequent coating, and also has a good deformability, good bonding properties and/or a good weldability. The transition from an anticorrosive coating (pretreatment coating) to a paint-like polymer-containing coating (base coat or paint intermediate coat between the base coat and toner=filler) may be continuous. In this connection one refers to the first paint coat or paint-like coat as the base coat, and the second paint coat or paint-like coat, as a so-called paint intermediate coat, in which connection this does not, like the filler, substantially affect the chromophoric properties of the paint system. The paint-like coating according to the invention is eminently suitable for producing a base coat or a so-called paint intermediate coat; it may then be used as desired to form the base coat and/or the paint intermediate coat. The anticorrosive coating should be regarded largely or wholly as a pretreatment coat directly or indirectly before the painting or before the coating with a paint-like polymer-containing coat, wherein also two or three pretreatment coats may be applied before the first paint coat or first paint-like coating. The term “painting” within the context of the present application also includes the application of paint-like coatings. Preferably the in each case last applied coat serves in turn as an eminently suitable adherent base for the next coating.

The term polymer includes in the structural sense before the progressive or complete crosslinking, in addition to polymers also monomers, oligomers, copolymers, block copolymers, cross polymers, mixtures, mixed polymers and/or their derivatives and/or, after the progressive or complete crosslinking, in addition to polymers also oligomers, copolymers, block copolymers, cross polymers, mixtures, mixed polymers and/or their derivatives. The term polymer includes in the chemical sense in addition to polymers—within the meaning of the generic expression defined above—based on resins, in particular based on synthetic resins such as for example acrylate, ethylene, polyester, polyurethane, silicone polyester, epoxide, phenol, styrene, styrene/butadiene, urea/formaldehyde and/or their derivatives, also polymers based on silanes/siloxanes and other polymers in the usual chemical sense.

The paint-like coating is normally intended to replace a paint coat and, being a primer, is meant in this connection to replace in particular the lowermost or the two lowermost, i.e. first paint coat(s) as base coat or paint intermediate coat. The object of the paint-like coating is that it should be particularly easy to form, particularly easy to weld, particularly easy to bond, particularly easy to clinch and/or particularly corrosion-resistant, although this coating or these coatings are normally intended to be much thinner than corresponding paint coats according to the prior art.

In this connection the sequence of the coatings according to the invention can be applied to one or both sides of the metal strip, in particular in the case of strips of ungalvanised steel sheet or steel sheet galvanised on only one side, or strips of aluminium or aluminium alloys. If only one side of the metal strip is coated according to the invention, then the other side can be coated for example with one, two or three pretreatment coats, for example with a phosphate layer or with an hexafluoride-containing layer, and then with a phosphate layer. Alternatively, the other side of the metal strip can also be coated with an anticorrosive oil and/or with a dry lubricant such as for example an easily removable polymer mixture, for example a mixture based on acrylate resin and polyethylene wax.

The term dispersion in the context of the present application is understood to be a generic term including for example emulsion, microemulsion and suspension.

The forming additive, which also acts in a corrosion-inhibiting manner, may at the same time also be the corrosion inhibitor, so that different additives do not have to be added for the forming and for the corrosion inhibition. The corrosion inhibitor may also at the same time fulfil other properties, for example in addition to the corrosion-inhibiting action it may also act as a bonding agent and/or crosslinking agent.

Preferably this high corrosion resistance in the mandrel bending test followed by the condensate water atmosphere test is achieved if surfaces treated in this way and tested over 1200 hours or particularly preferably over 2400 hours show no signs of corrosion of more than 5% on the unformed test surface.

In the method according to the invention the cured layer preferably has a satisfactory handling strength. In particular it may have a Persos pendulum hardness in the range from 30 to 550 sec.

The method according to the invention is characterised by the fact that the strip or the strip sections after painting with a paint-like coating is/are optionally cut and the painted strip sections are then formed and/or formed during the cutting, and are next optionally joined to other moulded parts, in particular by flanging, clinching, bonding, welding and/or other mechanical joining methods.

Dispersion According to the Invention for Formulating a Paint-Like Coating:

For the method according to the invention the dispersion may contain a resin or a mixture of resins selected from the group of derivatives based on acrylate, epoxide, phenol, polyethylene, polyurethane, polyester and styrene. The resins listed here and based on the aforementioned components may be present in the dispersion individually, as a mixture and/or chemically associated, and may be present in the form of monomer, oligomer, polymer, copolymer and/or their derivatives, all transitions being possible.

The content of binders, i.e. resins or corresponding derivatives, is preferably 18 to 80 wt. %, preferably 22 to 75 wt. %, in particular 25 to 45 wt. %, referred to the solids content. With coating plants that produce a relatively thick wet film—for example in the range from 5 to 15 μm—on the substrate, a low concentration of binders is preferred. On the other hand, with coating plants that produce a thinner wet film—for example in the range from 1.5 to 8 μm—a high concentration of binders is instead preferred. In the case where a reactive diluent is used, this addition is included in the binder content.

In addition the dispersion may contain at least one photoinitiator selected from the group comprising acetophenone, anthraquinone, benzoin, benzophenone, 1-benzoylcyclohexanol, phenyl ketone, thioxanthone and their derivatives, and/or at least one organophosphorus compound, such as for example an acyl phosphine oxide. Preferably the dispersion contains the photoinitiator in an amount of 0.1 to 7 wt. %, particularly preferably in an amount of 0.5 to 5 wt. %. The photoinitiator is converted under the action of UV radiation into at least one radical and/or cation that starts or promotes the polymerisation. By suitably choosing the resins to be crosslinked and the amounts of these resins and photoinitiator(s), a mixture can also be formulated in which the curing takes place in part by UV curing and in part by thermal crosslinking. The proportion of the crosslinking achieved by means of actinic radiation, in particular UV radiation, is in the paint-like coatings according to the invention 50% to 100%, preferably at least 65% and particularly preferably at least 95%.

The content of additives such as for example biocide, defoaming agent, coupling agent, catalyst, corrosion inhibitor, wetting agent, pigment (=nanoparticles) and/or forming additive, etc., may be 0.1 to 24 wt. %, preferably 3 to 18 wt. % and particularly preferably 5 to 12 wt. %. The content of emulsifier(s) is, since ready-to-use dispersions are often employed, counted as part of the raw material base of the binders and is therefore included here in the content of the binders. Wetting agents also often serve as coupling agents.

The content of water added separately, i.e. not added in the form of a dispersion or solution, may be 0 to 40 wt. %, preferably 5 to 25 wt. % and particularly preferably 8 to 18 wt. %. It may however also be preferred to add, instead of this water or a part of this water, additives and/or binders.

The total water content of the dispersion according to the invention may be 20 to 95 wt. %, preferably 25 to 85 wt. %. The total water content is essentially governed by the desired conditions for use. For rapid strip coating a total water content in the range from 70 to 80 wt. % may be of particular interest for example, while for the coating of parts the range may be from 85 to 95 wt. %.

The dispersion may contain at least one corrosion inhibitor selected from the group comprising organic, inorganic or organometallic compounds, coated or non-coated inorganic pigments such as for example Fe₂O₃, SiO₂ and/or TiO₂, nanoparticles, aluminium phosphates, antimony compounds such as antimony hydroxide, zinc phosphates, zinc salts of aminocarboxylates, 5-nitroisophthalic acid or cyanic acid, polymeric amino salts with fatty acids, TPA-amine complexes, phosphates and/or carbonates based on titanium or zirconium, metal salts of dodecylnaphthalenesulfonic acid, amino complexes and transition metal complexes of toluenepropionic acid, silanes or siloxanes, and 2-mercaptobenzothiazolylsuccinic acid or its amino salts. In addition a proportion of electrically conducting polymers may be added, for example based on polyaniline—in particular for corrosion protection reasons—which is why these are also regarded as corrosion inhibitors. The content of at least one corrosion inhibitor varies preferably in the range from 0.4 to 10 wt. %, particularly preferably in the range from 0.6 to 6 wt. %.

The dispersion also contains at least one forming additive. The dispersion may contain at least one wax as forming additive, in particular a wax selected from the group comprising paraffins, polyethylenes and polypropylenes, in particular an oxidised wax. The dispersion may inter alia be anionically or cationically stabilised because it can then easily be kept homogeneously distributed in the aqueous composition. In this connection the melting point of the wax used as lubricant may be in the range from 400 to 160° C., in particular in the range from 120° to 150° C. The content of at least one forming additive is preferably 0.3 to 10 wt. %, particularly preferably 0.6 to 8 wt. % and most particularly preferably at least 1 wt. %. The content of wax in the coatings produced with the dispersion according to the invention is substantial in order to permit easy sliding during the forming, which on account of the reduced forces leads to defect-free formed surfaces. In this way cracks and flaking in this coating are avoided. Defects and flakings rapidly lead to severe signs of corrosion.

A finely divided powder or a dispersion containing fine-grain particles, for example of a carbonate, oxide, silicate or sulfate, may be added as inorganic compound in particle form to the dispersion. This inorganic compound may be added to the dispersion in the form of particles having a particle size distribution substantially in the range from 5 nm to 300 nm, preferably in the range from 6 to 100 nm, particularly preferably in the range from 7 to 60 nm and most particularly preferably in the range from 8 to 25 nm. Particles based on aluminium oxide, barium sulfate, silicon dioxide, silicate, titanium dioxide, zinc oxide and/or zirconium oxide may preferably be added in particle form as inorganic compound. Electrically conducting particles, for example based on coated pigments, graphite/carbon black, iron phosphide, iron oxide or molybdenum sulfide, may however also be added. These anticorrosive layers are preferably free from elementary zinc.

At least one water-miscible and/or water-soluble alcohol, a glycol ether, N-methylpyrrolidone and/or water may be used as organic solvent for the organic polymers. In the case where a solvent mixture is used, it is recommended to use a mixture of at least one long-chain alcohol such as for example propylene glycol, an ester alcohol, a glycol ether and/or butanediol with water, otherwise the use of water alone, in particular fully deionised water, is recommended. The content of organic solvent may in this connection be 0.1 to 5 wt. %, preferably 0.2 to 2 wt. %. In addition free fluoride and/or complex fluoride based on aluminium, boron, silicon, titanium, hafnium and/or zirconium may be added. The content of complex fluoride in the dispersion according to the invention may preferably be in the range from 0.01 to 50 g/l, in particular in the range from 0.1 to 40 g/l, calculated as F₆. The content of free fluoride in the dispersion according to the invention may preferably be in the range from 0.01 to 10 g/l, in particular in the range from 0.1 to 8 g/l.

The acid groups of the synthetic resins may be stabilised with ammonia and/or with amines such as for example morpholine, dimethylethanolamine, diethylethanolamine or triethanolamine and/or with alkali metal hydroxides such as for example sodium hydroxide.

The aqueous composition may optionally contain in each case at least one biocide, an antifoaming agent and/or a wetting agent. The dispersion may also contain a wetting agent, in some circumstances based on polysiloxanes. The content of individual members of these substances should, when used, be as low as possible. Their overall content should not exceed 1 wt. %.

Oxane derivatives, formaldehyde donors and/or hydroxymethylureide may preferably be used as biocide. As antifoaming agents there may preferably be used those based on polysiloxane and/or on hydrophobic solids.

Metal Substrates or Metal-Coated Substrates, Their Pretreatment, Their Coating with the Paint-Like Coating and the Further Procedure:

The metal surface may consist substantially of aluminium, iron, copper, magnesium, nickel, titanium, zinc and/or of an aluminium, iron, copper, magnesium, nickel, titanium and/or zinc-containing alloy, or of several of these metal substances.

The metal surface may be cleaned and/or galvanised, in particular freshly cleaned or freshly galvanised, in which connection the galvanising may consist of zinc or a zinc-containing alloy, such as for example an aluminium-containing and/or iron-containing zinc alloy. Preferably the metal surface is hot-dipped alloy galvanised or electrolytically galvanised, or coated with an aluminium-zinc alloy as used for the production of Galfan® or Galvalume®.

The metal surface may contain at least 80% aluminium and may be cleaned, optionally pickled, optionally anodised and optionally passivated. Anodisation—optionally after a pickling—may be an alternative to pickling and passivation.

The metal surface may be cleaned and optionally pretreated, in particular pretreated with a pretreatment solution based on fluoride, iron-cobalt and/or phosphate.

The metal surface may be brought into contact with the dispersion in the roller application process, by wetting and squeezing, by flow coating or by dipping, a wet film being formed.

The metal surface may be wetted with the dispersion for a time ranging from 0.001 seconds up to 30 minutes, in the case of rapid coating of a strip in particular over a time of 0.001 to 1 second, and in the coating of parts over a time ranging from 10 seconds up to 30 minutes, preferably 1 to 5 minutes.

The metal surface may during the coating with the dispersion have a temperature in the range from 50 to 60° C., preferably in the range from 150 to 30° C., particularly preferably 18° to 25° C. The dispersion during the coating may have a temperature in the range from 50 to 60° C., preferably 15° to 30° C. and particularly preferably 18° to 25° C.

The metal surface contacted with the dispersion may be dried by the circulating hot air method, inductively and/or by radiation heat, the volatile constituents of the dispersion optionally being removed by blowing off.

The metal surface contacted with the dispersion may be dried at an object temperature in the range from room temperature up to 180° C., in the case of rapid strip coating and coating of parts preferably in the range from 50° C. to 100° C., in which connection drying may have to be continued longer in the case of parts, in particular more than 10 minutes up to 30 minutes.

The metal surface contacted with the dispersion may, if it is largely or wholly dried so as to be free of water, be irradiated with UV light preferably in the range from 180 nm to 500 nm in order to initiate and/or carry out the polymerisation reaction. The irradiation is preferably carried out over 0.005 seconds up to 5 minutes, in the case of rapid strip coating preferably over 0.005 up to 1 second, and in the case of parts preferably over 1 second up to 1 minute. The output of the UV radiator is nowadays preferably in the range from 20 to 250 W/cm. With substrates of complicated shape, such as for example moulded parts, it is recommended in many cases to use several UV radiators and optionally also mirrors in order to avoid non-irradiated parts of the organic coating and to be able to cure the whole coating simultaneously.

The metal surface contacted with the dispersion may be physically dried before or before and during the UV curing. In this connection the physical drying is important above all for the resin constituents, which cannot be crosslinked by UV curing.

An organic coating may be formed that, after curing, has a coat weight in the range from 0.2 to 20 g/cm², preferably in the range from 0.6 to 12 g/cm², in particular in the range from 1 to 5 g/cm². With coatings having a content of inorganic additives such as for example pigments, the coat weight for equal coat volumes is as a rule significantly higher than without these additives.

The cured organic coating may have a coat thickness of 0.1 to 10 μm, preferably from 0.3 to 5 μm, particularly preferably 0.5 to 3 μm. The cured coating should be suitably “paintable” for the subsequent coating with a paint or a paint-like coating; if necessary the chemical systems should be matched to one another.

The coated strips or strip sections may be coated with at least one further organic coating, in particular with a paint such as for example a top-coat, an adhesive layer, an adhesive carrier, a film, a foam and/or a printed layer.

The substrate with the cured coating may optionally be cut, formed, or bonded, welded, soldered, clinched, riveted or otherwise joined to another part. Soldering is possible only on clean uncoated substrates, which means that the coating has to be partially removed for this purpose. In the case of welding it is recommended that the organic coating according to the invention has a coat thickness of on average not more than 3 μm, preferably not more than 1.5 μm, and optionally also a relatively large proportion of at least one electrically conducting compound, in particular electrically conducting particles of less than 1 μm average size. The proportion of at least one electrically conducting compound or of electrically conducting particles is then preferably 5 to 75 wt. %, particularly preferably 10 to 60 wt. %, referred to the solids content, in which connection the composition of the mixture of the remaining constituents has to be suitably matched with higher proportions of electrically conducting substance. The thinner the coating according to the invention, the smaller may be the amounts of electrically conducting substance in the aqueous mixture. Depending on the circumstances, these amounts may be below 30 wt. %, preferably below 18 wt. %, referred to the solids content.

The dispersion according to the invention may also be employed largely or wholly free of heavy metals such as chromium, copper and nickel. In particular chromium-free methods in which no chromium is intentionally added are preferred. The dispersion according to the invention may also be formulated free of organic solvents.

With strip coatings this method may also be applied so that it does not have to be used in a separate strip coating plant, but can be applied following for example a galvanising operation in the same plant (galvanising line). Often this is even possible without loss of capacity of the plant.

The coating method according to the invention is preferably used at application temperatures in the range from 15° to 40° C. and preferably drying and UV curing are carried out only at temperatures in the range from 40° to 80° C., since the dispersion does not have to be heated and a relatively strong heating of the coated substrate is not necessary for the crosslinking, which means that energy can correspondingly be saved compared to thermal curing.

The paint-like coating according to the invention may, if relatively large amounts of pigments or colourant substances are not added, be executed in a transparent manner so that the optical impression of the metal surface can very largely be retained. When coating metal-coated steel sheets with thin organic coatings it is often desirable that the joint structure and the colour of the metal surface remain visible, since this is often necessary as a design feature in for example galvanised metal sheeting in the architectural sector.

It was surprising that the coating method according to the invention led to paint-like coatings that permitted a significant, largely crack-free—namely without noticeable effects on the corrosion resistance—expansion such as for example when forming using a conical mandrel.

The coating according to the invention with dispersions corresponding to Examples 1 to 4 surprisingly proved in the outdoor weathering test to be equivalent to the chromium-free coatings based on Galvalume®.

On account of the good corrosion resistance it is necessary only in some application cases, possibly only for reasons of colour painting and/or effect painting, to paint over the coating according to the invention.

The dispersion according to the invention may serve for the production of a coating that is used as a primer, in particular as a slip primer or welding primer. It may however also be used to produce a rear side coating such as for example a wash primer, which may be a less high-grade coating that the corresponding front side coating, in particular on galvanised steel sheets. The dispersion may also be used as a pretreatment primer that at the same time also performs the functions of an anticorrosive layer, so that the procedure may optionally be carried out without any anticorrosive coating, with a smaller number of anticorrosive coatings than would otherwise be used, with smaller coat thicknesses of an anticorrosive coating, with a qualitatively less high-grade anticorrosive coating and/or with a more economical anticorrosive coating on account of the use of a pretreatment primer.

Use of Anticorrosive Coatings or Paint-Like Coatings or Paint Coatings

When anticorrosive coatings are applied in the method according to the invention, then these may comprise one to four layers which, depending on the circumstances, may all be applied directly one after the other. Preferably at least two or three anticorrosive layers are applied one after the other. Each of these layers is preferably an anticorrosive coating selected from the group of coatings based on in each case iron-cobalt, nickel-cobalt, at least one fluoride, at least one complex fluoride, in particular tetrafluoride or hexafluoride, an organic hydroxy compound, a phosphate, a phosphonate, a polymer, a rare earth compound of at least one rare earth element including lanthanum and yttrium, a silane/siloxane, a silicate, cations of aluminium, magnesium and/or at least one transition metal selected from the group comprising chromium, iron, hafnium, cobalt, manganese, molybdenum, nickel, titanium, tungsten and zirconium, or a coating based on nanoparticles, though optionally at least one further anticorrosive coating may also be applied. In this connection the at least one further anticorrosive coating may be applied as desired before and/or after the first, second or third anticorrosive coating. It may be useful to apply more than one anticorrosive coating (pretreatment coating) since the subsequent paint-like or paint coats are often so thin compared to the paint systems according to the prior art that the requirements concerning corrosion prevention have to be increased accordingly.

In the method according to the invention the first anticorrosive coating may for example be applied in a drying-on process and the second anticorrosive coating in a drying-on process or rinse process.

A no-rinse process in which a liquid film is dried on the optionally precoated strip is described as a drying-on process. A coating process in which a coating is formed by reaction especially when spraying or dipping, in which the coating is then rinsed in order to remove excess chemicals and in which the coating is finally dried, is described as a rinse process. Coatings based for example on zinc phosphate and/or manganese phosphate and generally containing a low nickel content are preferably applied in the no-rinse process. However, many other types of coating compositions may also be dried on.

In this method the first anticorrosive coating may for example be applied in a rinse process, and the second anticorrosive coating may be applied in a drying-on process or rinse process.

In this connection the second anticorrosive coating may be applied in a post-rinsing stage, in particular after the first anticorrosive coating was previously applied in a galvanising line.

In the galvanising line the parts may preferably be electrolytically galvanised, electrolytically alloy-galvanised, hot galvanised, hot-dip galvanised and/or hot-dip alloy-galvanised. Coatings that may be applied include inter alia pure zinc, zinc of a purity in the range from 98% to 99.9%, aluminium-zinc alloys, zinc-aluminium alloys and zinc/nickel alloys.

In this connection the second anticorrosive coating may be applied in a drying-on process, in particular after the first anticorrosive coating was previously applied in a galvanising line. In the galvanising line the parts may preferably be electrolytically galvanised, hot galvanised, hot-dip galvanised and/or hot-dip alloy-galvanised.

In the method according to the invention surfaces of aluminium, iron, cobalt, copper, magnesium, nickel, titanium, tin, zinc or aluminium, or iron, cobalt, copper, magnesium, nickel, titanium, tin and/or zinc-containing alloys may be coated, and in particular electrolytically galvanised or hot galvanised surfaces may be coated. Preferred metal coatings on the metal strips include electrolytically galvanised steel, hot-dip galvanised steel, hot-dip alloy-galvanised steel or aluminium alloy coated with pure aluminium.

The pretreatment before the painting is preferably carried out in a chromium-free or largely chromium-free manner, in particular chromium-free to such an extent that no chromium is intentionally added. Preferably the pretreatment solutions also contain only minor amounts or are free in each case from cobalt, copper, nickel and/or other heavy metals.

In the method according to the invention the articles may be coated with at least one liquid, solution or suspension that is largely free or wholly free from chromium compounds, before the coating with at least one paint and/or with at least one paint-like polymer-containing coat that contains polymers, copolymers, cross polymers, oligomers, phosphonates, silanes and/or siloxanes. Largely free from chromium may denote in this context no intentional addition of a chromium compound. The term liquid also includes compounds or mixtures in solvent-free form or present in liquid form.

This method may be distinguished by the fact that no lead, cadmium, chromium, cobalt, copper and/or nickel is added to the liquid, solution or suspension for the first and/or second anticorrosive coating. Heavy metals such as lead, cadmium, chromium, cobalt, copper and/or nickel that are added are generally added only in the smallest possible amounts.

In the method according to the invention, on account of the at least one anticorrosive coating—in contrast to the prior art at the priority date—at least one of the otherwise conventional pretreatment coats, paint coats and/or paint-like polymer-containing coats can be omitted, in particular a pretreatment coat and a paint coat (see Tables 2A-J in the variants A et seq.).

In this connection, the liquid, solution or suspension for at least one of the anticorrosive coatings and/or paint-like polymer-containing coatings may contain, in addition to water, at least one organic film-forming agent with at least one water-soluble or water-dispersible polymer, copolymer, block copolymer, cross polymer, monomer, oligomer, their derivative(s), mixture(s) and/or mixed polymer(s). The proportion of these organic compounds in a layer is preferably in the range from 60 to 99.8 wt. % referred to the solids content.

In this connection, the liquid, solution or suspension for at least one of the anticorrosive coatings and/or paint-like polymer-containing coatings may contain, in addition to water, a total content of cations, tetrafluoro complexes and/or hexafluoro complexes of cations selected from the group comprising titanium, zirconium, hafnium, silicon, aluminium and boron and/or free or otherwise bound fluorine, in particular 0.1 to 15 g/l of complex fluoride referred to F₆, preferably 0.5 to 8 g/l of complex fluoride referred to F₆ and 0.1 to 1000 mg/l of free fluoride. The proportion of these compounds in a coating is preferably in the range from 5 to 99.9 wt. %.

In this connection, the liquid, solution or suspension for at least one of the anticorrosive coatings and/or paint-like polymer-containing coatings may contain, in addition to water, a total-content of free fluorine or fluorine not bound to tetrafluoro or hexafluoro complexes, in particular 0.1 to 1000 mg/l calculated as free fluorine, preferably 0.5 to 200 mg/l, particularly preferably 1 to 150 mg/l.

In the method according to the invention the liquid, solution or suspension for at least one of the anticorrosive coatings, paint coats and/or paint-like polymer-containing coatings may contain, in addition to water, at least one inorganic compound in particle form with a mean particle diameter measured in a scanning electron microscope in the range from 0.003 to 1 μm diameter, preferably in the range from 0.005 to 0.2 μm diameter, in particular based on Al₂O₃, BaSO₄, rare earth oxide(s), at least one other rare earth compound, SiO₂, silicate, TiO₂, Y₂O₃, Zn, ZnO and/or ZrO₂, preferably in an amount in the range from 0.1 to 80 g/l, particularly preferably in an amount in the range from 1 to 50 g/l, most particularly preferably in an amount in the range from 2 to 30 g/l. The proportion of these compounds in particle form in a coating is preferably in the range from 5 to 90 wt. %, particularly preferably in the range from 10 to 50 wt. %. Electrically conducting particles may also be used, such as for example iron oxide, iron phosphide, molybdenum compounds such as molybdenum sulfide, graphite and/or carbon black and/or also an addition of electrically conducting polymers, if the metal sheets are to be joined possibly by welding. Preferably these anticorrosive coatings are free from elementary zinc.

In the method according to the invention the liquid, solution or suspension for at least one of the anticorrosive coatings, paint coats or paint-like polymer-containing coatings may contain at least one corrosion inhibitor selected from the group comprising organic phosphate compounds, phosphonate compounds, organic morpholine and thio compounds, aluminates, manganates, titanates and zirconates, preferably alkylmorpholine complexes, organic Al, Mn, Ti and/or Zr compounds, in particular of olefinically unsaturated carboxylic acids, for example ammonium salts of carboxylic acids such as chelated lactic acid titanate, triethanolamine titanate or zirconate, Zr-4-methyl-γ-oxo-benzenebutanoic acid, aluminium-zirconium carboxylate, alkoxypropenol titanate or zirconate, titanium acetate and/or zirconium acetate and/or their derivatives, and Ti/Zr ammonium carbonate. The proportion of these compounds in a coating is preferably in the range from 5 to 40 wt. %.

In this connection, the liquid, solution or suspension for at least one of the anticorrosive coatings, paint coats or paint-like polymer-containing coatings may contain at least one compound for the, in particular, slow neutralisation of comparatively acidic mixtures and/or for corrosion protection of unprotected or damaged parts of the metal surface, preferably based on carbonate or hydroxycarbonate or electrically conducting polymers, particularly preferably at least one basic compound with a layer structure such as for example Al-containing hydroxycarbonate hydrate (hydrotalcite). The proportion of these compounds in a coating is preferably in the range from 3 to 30 wt. %.

In this connection, the liquid, solution or suspension for at least one of the anticorrosive coatings, paint coats and/or paint-like polymer-containing coatings may contain, in addition to water, at least one silane and/or siloxane calculated as silane, in particular in an amount in the range from 0.1 to 50 g/l, preferably in an amount in the range from 1 to 30 g/l.

In this connection, the liquid, solution or suspension for at least one of the anticorrosive coatings, paint coats and/or paint-like polymer-containing coatings may contain, in addition to water and/or at least one organic solvent, also at least one silane and/or siloxane calculated as silane, in particular in an amount in the range from 51 to 1300 g/l.

In this connection, the liquid, solution or suspension for at least one of the anticorrosive coatings, paint coats and/or paint-like polymer-containing coatings may contain, optionally in addition to water and/or at least one organic solvent, also at least one silane and/or siloxane calculated as silane, in particular in an amount in the range from 0.1 to 1600 g/l, preferably in an amount in the range from 100 to 1500 g/l.

The silane may be an acyloxysilane, an alkylsilane, an alkyltrialkoxysilane, an aminosilane, an aminoalkylsilane, an aminopropyltrialkoxysilane, a bis-silylsilane, an epoxysilane, a fluoroalkylsilane, a glycidoxysilane such as for example a glycidoxyalkyltrialkoxysilane, an isocyanatosilane, a mercaptosilane, a (meth)acrylatosilane, a mono-silylsilane, a multi-silylsilane, a bis-(trialkoxysilylpropyl)amine, a bis-(trialkoxysilyl)ethane, a sulfur-containing silane, a bis-(trialkoxysilyl)propyl-tetrasulfane, a ureidosilane such as for example a (ureidopropyltrialkoxy)silane and/or a vinylsilane, in particular a vinyltrialkoxysilane and/or a vinyltriacetoxysilane. There may for example be at least one silane in the mixture with a content of at least one alcohol such as ethanol, methanol and/or propanol of up to 8 wt. % referred to the silane content, preferably up to 5 wt. %, particularly preferably up to 1 wt. % and most particularly preferably up to 0.5 wt. %, optionally with a content of inorganic particles, in particular in a mixture of at least one aminosilane such as for example bis-aminosilane with at least one alkoxysilane such as for example trialkoxysilyl-propyltetrasulfane or a vinylsilane and a bis-silylaminosilane or a bis-silyl-polysulfursilane and/or a bis-silylaminosilane or an aminosilane and a multisilyl-functional silane.

In the method according to the invention the liquid, solution or suspension for at least one of the anticorrosive coatings, paint coats and/or paint-like polymer-containing coatings may contain an organic film-forming agent in the form of a solution, dispersion, emulsion, microemulsion and/or suspension.

In this connection, the liquid, solution or suspension for at least one of the anticorrosive coatings, paint coats and/or paint-like polymer-containing coatings may contain as organic film-forming agent at least one synthetic resin, in particular at least one synthetic resin based on acrylate, ethylene, polyester, polyurethane, silicone polyester, epoxide, phenol, styrene, styrene/butadiene, urea/formaldehyde, their derivatives, copolymers, block copolymers, cross polymers, monomers, oligomers, polymers, mixtures and/or mixed polymers. The term “polymer” is used here—in particular also for the paint-like coatings—as a generic term for all these variants of synthetic resins and their derivatives, copolymers, block copolymers, cross polymers, monomers, oligomers, polymers, mixtures and mixed polymers.

In this connection, the liquid, solution or suspension for at least one of the anticorrosive coatings, paint coats and/or paint-like polymer-containing coatings may contain as organic film-forming agent a synthetic resin mixture and/or mixed polymer that has a content of synthetic resin based on acrylate, ethylene, urea/formaldehyde, polyester, polyurethane, styrene and/or styrene/butadiene or their derivatives, copolymers, cross polymers, oligomers, polymers, mixtures and/or mixed polymers, from which an organic film is formed during or after the release of water and other volatile constituents.

In this connection, the liquid, solution or suspension for at least one of the anticorrosive coatings, paint coats and/or paint-like polymer-containing coatings may contain as organic film-forming agents synthetic resins and/or polymers, copolymers, block copolymers, cross polymers, monomers, oligomers, polymers, mixtures and/or mixed polymers or their derivatives based on acrylate, polyethyleneimine, polyurethane, polyvinyl alcohol, polyvinylphenol, polyvinylpyrrolidone and/or polyaspartic acid, in particular copolymers with a phosphorus-containing vinyl compound.

In this connection, the liquid, solution or suspension for at least one of the anticorrosive coatings, paint coats and/or paint-like polymer-containing coatings may contain synthetic resin whose acid number is in the range from 5 to 250. Preferably the acid number is in the range from 10 to 140, particularly preferably in the range from 15 to 100.

In this connection, the liquid, solution or suspension for at least one of the anticorrosive coatings, paint coats and/or paint-like polymer-containing coatings may contain synthetic resins and/or polymers, copolymers, block copolymers, cross polymers, monomers, oligomers, polymers, mixtures and/or mixed polymers and/or their derivatives, whose molecular weights are in the region of 1000, preferably at least 5000 up to 500,000, and particularly preferably in the range from 20,000 to 200,000.

In this connection, the liquid, solution or suspension for at least one of the anticorrosive coatings, paint coats and/or paint-like polymer-containing coatings may contain synthetic resins and/or polymers, block copolymers, copolymers, cross polymers, monomers, oligomers, polymers, mixtures and/or mixed polymers or their derivatives, especially also based on pyrrolidone(s), in particular in an amount of 0.1 to 500 g/l, preferably 0.5 to 30 g/l or 80 to 250 g/l.

In this connection, the liquid, solution or suspension for at least one of the anticorrosive coatings, paint coats and/or paint-like polymer-containing coatings may contain an organic film-forming agent whose pH value in an aqueous preparation without addition of further compounds is in the range from 1 to 12, preferably in the range from 2 to 10, particularly preferably in the range from 2.5 to 9.

In this connection, the liquid, solution or suspension for at least one of the anticorrosive coatings, paint coats and/or paint-like polymer-containing coatings may contain an organic film-forming agent that contains only water-soluble synthetic resins and/or polymers, copolymers, block copolymers, cross polymers, monomers, oligomers, polymers, mixtures and/or mixed polymers or their derivatives, in particular those that are stable in solutions with pH values ≦5.

In this connection, the liquid, solution or suspension for at least one of the anticorrosive coatings, paint coats and/or paint-like polymer-containing coatings may contain an organic film-forming agent whose synthetic resins and/or polymers, copolymers, block copolymers, cross polymers, monomers, oligomers, polymers, mixtures and/or mixed polymers or their derivatives have carboxyl groups.

In this connection, the liquid, solution or suspension for at least one of the anticorrosive coatings, paint coats and/or paint-like polymer-containing coatings may contain an organic film-forming agent in which the acid groups of the synthetic resins and/or polymers, copolymers, block copolymers, cross polymers, monomers, oligomers, polymers, mixtures and/or mixed polymers or their derivatives are stabilised with ammonia, with amines such as for example morpholine, dimethylethanolamine, diethylethanolamine or triethanolamine and/or with alkali metal compounds such as for example sodium hydroxide.

In the method according to the invention, the liquid, solution or suspension for at least one of the anticorrosive coatings, paint coats and/or paint-like polymer-containing coatings contains 0.1 to 200 g/l and preferably 0.3 to 50 g/l of the organic film-forming agent, in particular 0.6 to 20 g/l.

In this connection, the liquid, solution or suspension for at least one of the anticorrosive coatings, paint coats and/or paint-like polymer-containing coatings may contain 100 to 2000 g/l and preferably 300 to 1800 g/l of the organic film-forming agent, in particular 800 to 1400 g/l.

In the method according to the invention, the liquid, solution or suspension for at least one of the anticorrosive coatings, paint coats and/or paint-like polymer-containing coatings may contain an amount of monomers, in particular in the region of at least 5 wt. %, preferably at least 20 wt. %, particularly preferably at least 40 wt. %. In this connection, in particular with a high content of monomers the amount of water or organic solvent may optionally be reduced and may in particular be less than 10 wt. %; depending on circumstances the mixture may even be largely or wholly free of water and/or organic solvent.

In the method according to the invention, the liquid, solution or suspension for at least one of the anticorrosive coatings, paint coats and/or paint-like polymer-containing coatings may contain 0.1 to 50 g/l of cations, tetrafluoro complexes and/or hexafluoro complexes of cations selected from the group comprising titanium, zirconium, hafnium, silicon, aluminium and boron, preferably hexafluoro complexes of titanium, zirconium and/or silicon, preferably a coating of 2 to 20 g/l.

In this connection, the liquid, solution or suspension for at least one of the anticorrosive coatings, paint coats and/or paint-like polymer-containing coatings may contain at least one organometallic compound, in particular with a content of titanium and/or zirconium. These organometallic compounds are often corrosion inhibitors and often also at the same time coupling agents.

In the method according to the invention, the liquid, solution or suspension for at least one of the anticorrosive coatings, paint coats and/or paint-like polymer-containing coatings may also contain at least one silane and/or siloxane, calculated as silane, in the aqueous composition, preferably in an amount from 0.2 to 40 g/l, particularly preferably in an amount of 0.5 to 10 g/l.

In this connection, the liquid, solution or suspension for at least one of the anticorrosive coatings, paint coats and/or paint-like polymer-containing coatings may contain at least one partially hydrolysed silane, at least one wholly hydrolysed silane and/or at least one siloxane. During the hardening of the coating, siloxanes are formed from the silanes. Corresponding siloxanes may however also be added. The silanes/siloxanes may be used either alone, in a mixture with for example at least one fluoride complex, or also together with polymers.

In this connection, the liquid, solution or suspension for at least one of the anticorrosive coatings, paint coats and/or paint-like polymer-containing coatings may contain at least one partially hydrolysed and/or non-hydrolysed silane, in particular with a silane content of more than 100 g/l, particularly preferably with a silane content of more than 1000 g/l.

In this connection, the liquid, solution or suspension for at least one of the anticorrosive coatings, paint coats and/or paint-like polymer-containing coatings may in each case contain at least one acyloxysilane, an alkylsilane, an aminosilane, a bis-silylsilane, an epoxysilane, a fluoroalkylsilane, a glycidoxysilane, an isocyanatosilane, a mercaptosilane, a (meth)acrylatosilane, a mono-silylsilane, a multi-silylsilane, a sulfur-containing silane, a ureidosilane, a vinylsilane and/or at least one corresponding siloxane.

In the method according to the invention, there may be added to the liquid, solution or suspension for at least one of the anticorrosive coatings, paint coats and/or paint-like polymer-containing coatings, as inorganic compound in particle form, a finely divided powder, a dispersion or a suspension, such as for example a carbonate, oxide, silicate or sulfate, in particular colloidal or amorphous particles.

In this connection, there may be added to the liquid, solution or suspension for at least one of the anticorrosive coatings, paint coats and/or paint-like polymer-containing coatings, as inorganic compound in particle form, particles with a mean particle size in the range from 4 nm to 150 nm, in particular in the range from 10 to 120 nm. The mean size of the electrically conducting particles of a welding primer may be in the range from 0.02 to 15 μm.

In this connection, there may be added to the liquid, solution or suspension for at least one of the anticorrosive coatings, paint coats and/or paint-like polymer-containing coatings, as inorganic compound in particle form, particles based on at least one compound of aluminium, barium, cerium, calcium, lanthanum, silicon, titanium, yttrium, zinc and/or zirconium.

In this connection, the liquid, solution or suspension for at least one of the anticorrosive coatings, paint coats and/or paint-like polymer-containing coatings may contain 0.1 to 300 g/l, preferably 0.2 to 60 g/l of at least one inorganic compound in particle form.

In the method according to the invention the liquid, solution or suspension for at least one of the anticorrosive coatings, paint coats and/or paint-like polymer-containing coatings may contain as organic solvent for the organic polymers at least one water-miscible and/or water-soluble alcohol, a glycol ether or a pyrrolidone such as for example N-methylpyrrolidone and/or water, and in the case where a solvent mixture is used may contain in particular a mixture of at least one long-chain alcohol such as for example propylene glycol, an ester alcohol, a glycol ether and/or butanediol with water, preferably however only water without organic solvent.

In the method according to the invention the liquid, solution or suspension for at least one of the anticorrosive coatings, paint coatings and/or paint-like polymer-containing coatings may contain organic solvents in an amount of 0.1 to 10 wt. %.

In the method according to the invention the liquid; solution or suspension for at least one of the anticorrosive coatings, paint coats and/or paint-like polymer-containing coatings may contain as lubricant at least one wax selected from the group comprising paraffins, polyethylenes and polypropylenes, in particular an oxidised wax. The amount of waxes in a coat is preferably in the range from 0.1 to 20 wt. %.

In this connection the liquid, solution or suspension for at least one of the anticorrosive coatings, paint coats and/or paint-like polymer-containing coatings may contain, as lubricant, a wax whose melting point is in the range from 400 to 160° C. preferably in an amount of 0.1 to 100 g/l, particularly preferably 20 to 40 g/l or 0.1 to 10 g/l, and most particularly preferably 0.4 to 6 g/l, for example a crystalline polyethylene wax.

In the method according to the invention the liquid, solution or suspension for at least one of the anticorrosive coatings, paint coats and/or paint-like polymer-containing coatings may contain at least one rare earth element compound, in particular at least one compound selected from the group comprising chloride, nitrate, sulfate, sulfamate as well as complexes with for example a halogen or with an aminocarboxylic acid, in particular complexes with EDTA, NTA or HEDTA, scandium, yttrium and lanthanum also being counted as rare earth elements.

In this connection the liquid, solution or suspension for at least one of the anticorrosive coatings, paint coatings and/or paint-like polymer-containing coatings may contain a rare earth element compound of and/or with cerium, in particular in a mixture with other rare earth elements, for example at least partially based on mixed metal. The content of cerium compounds in a coat is preferably in the range from 0.1 to 99 wt. %, particularly preferably in the range from 25 to 95 wt. %. Preferably the at least one rare earth element compound in the aqueous solution is used in an amount of 1 to 80 g/l together with chloride in an amount in the region of at least 10 mg/l, with peroxide, calculated as H₂O₂, in an amount in the range from 1 to 50 g/l and with at least one cation selected from main group V or VI of the Periodic System of the Elements, in particular bismuth ions, in an amount in the range from 0.001 to 1 g/l. Preferably the amount of the at least one rare earth element compound in the aqueous solution is 5 to 25 g/l, together with an amount of chloride in the region of at most 500 mg/l, with an amount of peroxide, calculated as H₂O₂, in the range from 5 to 25 g/l, and with an amount of at least one cation selected from main groups V or VI of the Periodic System of the Elements, in particular bismuth ions, in the range from 0.01 to 0.3 g/l.

In the method according to the invention the liquid, solution or suspension for at least one of the anticorrosive coatings, paint coatings and/or paint-like polymer-containing coatings may contain at least one oxidising agent, in particular a peroxide, at least one accelerator and/or at least one catalyst, preferably a compound or ions of Bi, Cu and/or Zn.

In the method according to the invention the liquid, solution or suspension for at least one of the anticorrosive coatings, paint coatings and/or paint-like polymer-containing coatings may contain at least one compound selected from the group comprising mono-silanes, bis-silanes and multi-silanes, in particular:

mono-silanes of the general formula SiXₘY₄₋ₘ where m=1 to 3, preferably m=2 to 3,

where X=alkoxy, in particular methoxy, ethoxy and/or propoxy, and

where Y is a functional organic group selected from acyloxy, alkyl, acrylate, amino, epoxy, fluoroalkyl, glycidoxy, urea, isocyanate, mercapto, methacrylate and/or vinyl or their derivatives,

bis-silanes of the general formula Y₃₋ₚXₚ—Si-Z-Si—XₙY₃₋ₙ

where p and n=1 to 3 and are identical or different,

where X=alkoxy, in particular methoxy, ethoxy and/or propoxy,

where Y are functional organic groups selected from acyloxy, alkyl, acrylate, amino, epoxy, fluoroalkyl, glycidoxy, urea, isocyanate, mercapto, methacrylate and/or vinyl or their derivatives,

where Z is selected from the group comprising CₙH₂ₙ where n=2 to 20, in each case branched or unbranched; singly unsaturated alkyl chains of the general formula CₙH₂ₙ₋₂ where n=2 to 20, in each case branched or unbranched; doubly and/or multiply unsaturated alkyl compounds of the general formulae CₙH₂ₙ₋₄ where n=4 to 20, in each case branched or unbranched, CₙH₂ₙ₋₆ where n=6 to 20, in each case branched or unbranched, or CₙH₂ₙ₋₈ where n=8 to 20, in each case branched or unbranched; ketones, monoalkylamines, NH and sulfur S_{q} where q=1 to 20,

multi-silanes of the general formula Y₃₋ₚXₚ—Si-Z′-Si—XₙY₃₋ₙ

where p and n=1 to 3 and are identical or different,

where X=alkoxy, in particular methoxy, ethoxy and/or propoxy,

where Y are functional organic groups selected from acyloxy, alkyl, acrylate, amino, epoxy, fluoroalkyl, glycidoxy, urea, isocyanate, mercapto, methacrylate, mono/bis/multi-silyl and vinyl or their derivatives,

and where Z′=N—Si—XᵣY₃₋ᵣ where r=1 to 3, or sulfur S_{q} where q=1 to 20,

multi-silanes of the general formula Y₃₋ₚXₚ—Si-Z″-Si—XₙY₃₋ₙ

where p and n=1 to 3 and are identical or different,

where X=alkoxy, in particular methoxy, ethoxy and/or propoxy,

where Y are functional organic groups selected from acyloxy, alkyl, acrylate, amino, epoxy, fluoroalkyl, glycidoxy, urea, isocyanate, mercapto, methacrylate, mono/bis/multi-silyl and vinyl or their derivatives,

and where Z″=—R—C[(SiXₛY₃₋ₛ)(SiXₜY₃₋ₜ)]—R′, or sulfur S_{q} where q=1 to 20,

where s and t=1 to 3 and are identical or different,

where R and R′ are identical or different and are selected from the group comprising CₙH₂, where n=2 to 20, in each case branched or unbranched; singly unsaturated alkyl chains of the general formula CₙH₂ₙ₋₂ where n=2 to 20, in each case branched or unbranched, doubly and/or multiply unsaturated alkyl compounds of the general formulae CₙH₂ₙ₋₄ where n=4 to 20, in each case branched or unbranched, CₙH₂ₙ₋₆ where n=6 to 20, in each case branched or unbranched, or CₙH₂ₙ₋₈ where n=8 to 20, in each case branched or unbranched; ketones, monoalkylamines and NH,

wherein the silanes may in each case be present hydrolysed, partially hydrolysed and/or non-hydrolysed in a solution, emulsion and/or suspension.

In this connection the total content of silanes and siloxanes per coat is on the one hand preferably in the range from 0.01 to 20 wt. %, and on the other hand is preferably in the range from 60 to 99.9 wt. %.

In the method according to the invention the liquid, solution or suspension for at least one of the anticorrosive coatings may contain at least one compound of the type XYZ, X*Y*Z* and/or X*Y*Z*Y*X*,

wherein Y is an organic group with 2 to 50 C atoms,

wherein X and Z are identical or different and are an OH, SH, NH₂, NHR′, CN, CH═CH₂, OCN, CONHOH, COOR′, acrylic acid amide, epoxy, CH₂═CR″—COO, COOH, HSO₃, HSO₄, (OH)₂PO, (OH)₂PO₂, (OH)(OR′)PO, (OH)(OR′)PO₂, SiH₃ and/or an Si(OH)₃ group,

wherein R′ is an alkyl group with 1 to 4 C atoms,

wherein R″ is an H atom or an alkyl group with 1 to 4 C atoms, and

wherein the groups X and Z are in each case bonded to the group Y in the terminal position,

wherein Y* is an organic group with 1 to 30 C atoms,

wherein X* and Z* are identical or different and are an OH, SH, NH₂, NHR′, CN, CH═CH₂, OCN, CONHOH, COOR′, acrylic acid amide, epoxy, CH₂═CR″—COO, COOH, HSO₃, HSO₄, (OH)₂PO, (OH)₂PO₂, (OH)(OR′)PO, (OH)(OR′)PO₂, SiH₃, Si(OH)₃, >N—CH₂—PO(OH)₂, and/or an —N—[CH₂—PO(OH)₂]₂ group,

wherein R′ is an alkyl group with 1 to 4 C atoms, and

wherein R″ is an H atom or an alkyl group with 1 to 4 C atoms.

In this connection the liquid, solution or suspension for at least one of the anticorrosive coatings may contain at least one compound of the type XYZ, wherein X is a COOH, HSO₃, HSO₄, (OH)₂PO, (OH)₂PO₂, (OH)(OR′)PO or (OH)(OR′)PO₂, group,

wherein Y is an organic group R that contains 2 to 50 C atoms, of which at least 60% of the C atoms are present as CH₂ groups,

wherein Z is an OH, SH, NH₂, NHR′, CN, CH═CH₂, OCN, epoxy, CH═CR″—COOH, acrylic acid amide, COOH, (OH)₂PO, (OH)₂PO₂, (OH)(OR′)PO or (OH)(OR′)PO₂ group,

wherein R′ is an alkyl group with 1 to 4 C atoms,

and wherein R″ is an H atom or an alkyl group with 1 to 4 C atoms, preferably in a total amount of 0.01 to 10 g/l, more preferably 0.05 to 5 g/l and most particularly preferably 0.08 to 2 g/l.

In this connection the compound of the type XYZ, X*Y*Z* and/or X*Y*Z*Y*X* may be suitable for forming self-assembling molecules that are able to form a layer of these self-assembling molecules in particular on the metal surface, preferably a monomolecular layer.

In this connection the liquid, solution or suspension for at least one of the anticorrosive coatings may contain at least one of the following compounds of the type XYZ, X*Y*Z* and/or X*Y*Z*Y*X*:

1-phosphonic acid-12-mercaptododecane,

1-phosphonic acid-12-(N-ethylamino)dodecane,

1-phosphonic acid-12-dodecene,

p-xylylene-diphosphonic acid,

1,10-decanediphosphonic acid,

1,12-dodecanediphosphonic acid,

1,14-tetradecanediphosphonic acid,

1-phosphoric acid-12-hydroxydodecane,

1-phosphoric acid-12-(N-ethylamino)dodecane,

1-phosphoric acid-12-dodecene,

1-phosphoric acid-12-mercaptododecane,

1,10-decanediphosphoric acid,

1,12-dodecanediphosphoric acid,

1,14-tetradecanediphosphoric acid,

p,p′-biphenyldiphosphoric acid,

1-phosphoric acid-12-acryloyldodecane,

1,8-octanediphosphonic acid,

1,6-hexanediphosphonic acid,

1,4-butanediphosphonic acid,

1,8-octanediphosphoric acid,

1,6-hexanediphosphoric acid,

1,4-butanediphosphoric acid,

aminotrimethylenephosphonic acid,

ethylenediaminetetramethylenephosphonic acid,

hexamethylenediaminetetramethylenephosphonic acid,

diethylenetriaminepentamethylenephosphonic acid,

2-phosphonbutane-1,2,4-tricarboxylic acid.

The content of compounds of these types in a coating is preferably in the range from 50 to 100 wt. %.

In the method according to the invention at least one of the liquids, solutions or suspensions for at least one of the anticorrosive coatings and/or paint-like polymer-containing coatings may contain phosphate and zinc, and optionally also manganese, nickel and/or copper. The content of phosphates in a coat is preferably in the range from 8 to 100 wt. %, particularly preferably in the range from 20 to 95 wt. %, and most particularly preferably in the range from 60 to 90 wt. %.

In the method according to the invention at least one of the liquids, solutions or suspensions for at least one of the anticorrosive coatings and/or paint-like polymer-containing coatings may contain 0.1 to less than 100 g/l of zinc ions, 0.4 to 80 g/l of manganese ions, up to 12 g/l of nickel ions, up to 100 g/l of peroxide calculated as H₂O₂ and 1 to 500 g/l of phosphate ions calculated as P₂O₅, as well as preferably 0.2 to less than 50 g/l of zinc ions, 0.5 to 45 g/l of manganese ions and 2 to 300 g/l of phosphate ions, calculated as P₂O₅.

In the method according to the invention at least one of the liquids, solutions or suspensions for at least one of the anticorrosive coatings and/or paint-like polymer-containing coatings may contain phosphate, preferably based on Zn or ZnMn, optionally with a content of nickel.

In the method according to the invention at least one of the liquids, solutions or suspensions for at least one of the anticorrosive coatings, paint coats and/or paint-like polymer-containing coatings may contain phosphate, fluoride, tetrafluoride and/or hexafluoride. Preferably however phosponate(s), which are aligned at least partially as self-assembling molecules on the metal surface, and fluoride complexes, are formed with separate solutions in largely separate layers.

In the method according to the invention at least one of the liquids, solutions or suspensions for at least one of the anticorrosive coatings, paint coats and/or paint-like polymer-containing coatings may contain phosphonate, tetrafluoride and/or hexafluoride.

In the method according to the invention at least one of the liquids, solutions or suspensions for at least one of the anticorrosive coatings, paint coats and/or paint-like polymer-containing coatings may contain an organic film-forming agent, fluoride, tetrafluoride, hexafluoride and/or at least one inorganic compound in particle form and optionally at least one silane.

In the method according to the invention at least one of the liquids, solutions or suspensions for at least one of the anticorrosive coatings, paint coats and/or paint-like polymer-containing coatings may contain an additive selected from the group comprising organic binders, biocides, antifoaming agents, corrosion inhibitors, coupling agents, wetting agents, photoinitiators and polymerisation inhibitors.

In the method according to the invention at least one of the liquids, solutions or suspensions for at least one of the anticorrosive coatings, paint coats and/or paint-like polymer-containing coatings may contain at least one filler and/or a pigment, in particular at least one electrically conducting pigment, selected from the group comprising dyes, colour pigments, graphite, graphite-mica pigments, oxides such as iron oxides, molybdenum compounds, phosphates, phosphides such as iron phosphides, carbon black and zinc. The content of such compounds in a coat is preferably in the range from 0.1 to 60 wt. %, particularly preferably in the range from 5 to 35 wt. %.

In the method according to the invention an activating treatment, preferably an activation based on titanium, may be carried out before the application of an anticorrosive coating, paint coat or paint-like polymer-containing coating.

In the method according to the invention a post-rinsing and/or passivation may be carried out after the application of an anticorrosive coating, paint coat or paint-like polymer-containing coating, preferably a post-rinsing solution based on rare earth compounds, complex fluorides, silanes, titanium compounds and/or zirconium compounds, or a passivating solution based on rare earth compounds, complex fluorides, silanes, titanium compounds and/or zirconium compounds.

In the method according to the invention at least one of the liquids, solutions or suspensions for at least one of the anticorrosive coatings, paint coats and/or paint-like polymer-containing coatings may contain an organic film-forming agent that is cured, after application to the metal substrate, by heat and/or actinic radiation, in particular by an electron beam, UV radiation and/or visible light radiation.

In the method according to the invention at least one of the anticorrosive coatings, paint coats and/or paint-like polymer-containing coatings may be only partially cured before the bonding, welding and/or forming, and fully cured only after the said bonding, welding and/or forming, wherein the first curing is carried out before the bonding, welding and/or forming by actinic radiation—in particular by an electron beam, UV and/or visible light radiation—and the second curing is carried out after the bonding, welding and/or forming, preferably thermally and in particular by radiation heat and/or hot air. The first curing is preferably carried out in a non-thermal manner, in particular by UV radiation, since metal strip plants, in particular strip galvanising plants, do not normally include heating ovens. The second curing is preferably carried out thermally, particularly if the sheet metal is also to be post-cured. The second curing is preferably carried out however by actinic radiation, in particular by UV radiation, since the full curing produced in this way is often better than that produced just by thermal crosslinking. Moreover, more than one type of curing can also be used in each case in one of the curing steps.

In the method according to the invention the liquid, solution or suspension for at least one of the anticorrosive coatings, paint coatings and/or paint-like polymer-containing coatings may have a pH value in the range from 0.5 to 12, preferably in the range from 1 to 11, particularly preferably in the range from 2 to 10.

In the method according to the invention the liquid, solution or suspension for at least one of the anticorrosive coatings, paint coatings and/or paint-like polymer-containing coatings may be applied at a temperature in the range from 5° to 95° C., preferably in the range from 5° to 50° C., to the respective surface, and most particularly preferably in the range from 10° to 40° C.

In this connection the substrate and/or the respective surface may be kept at temperatures in the range from 5° to 120° C. during the application of the anticorrosive coating(s). The substrate in the first coating may be the metal surface itself. The first or second anticorrosive coating or the base coat may preferably be applied in a temperature range from 100 to 50° C.

In this connection, the coated metal surface may be dried at a temperature in the range from 20° to 400° C. PMT (Peak Metal Temperature). The first and second anticorrosive coatings may preferably be applied in a temperature range from 15° to 100° C., and the base coat may be applied in particular in a temperature range from 150 to 270° C.

In the method according to the invention the coated strips are cut up or wound into a coil, optionally after cooling to a temperature in the range from 10° to 70° C.

Method according to one of the preceding claims, characterised in that the divided up strips are coated with a temporarily applied coating that is subsequently removed, or with a permanent protective coating, in the edge region after the pressing, cutting and/or punching, for example with at least one coating based on dry lubricant, phosphate, hexafluoride, paint-like coating and/or paint.

In the method according to the invention the liquid, solution or suspension for at least one of the anticorrosive coatings, paint coatings and/or paint-like polymer-containing coatings may be applied by roller coating, flow coating, knife coating, spray coating, sprinkling, brushing or dipping, if necessary followed by squeezing with a roller.

In the method according to the invention the coating applied in each case with the liquid, solution or suspension for at least one of the anticorrosive coatings, paint coatings and/or paint-like polymer-containing coatings may be adjusted to a coat weight in the range from 0.0005 mg/m² to 150 g/m², preferably in the range from 0.0008 mg/m² to 30 g/m², particularly preferably in the range from 0.001 mg/m² to 10 g/m², and especially in the range from 1 to 6 g/m².

In the method according to the invention at least one coating of paint or of a paint-like, polymer-containing coating can be applied in each case to the partially or completely cured film, in which the first paint coat or paint-like polymer-containing coating may be a coating consisting substantially of a primer, a thin—in the range from 0.1 to 10 μm, preferably in the range from 0.15 to 6 μm, particularly preferably in the range from 0.2 to 4 μm—organically applied polymer-containing material (so-called permanent coating), a reaction primer, a shop primer or a wash primer. Within the context of the present application a reaction primer is understood to be a primer such as for example a coil coating primer, a primer replacing a cathodic dipping paint, or a welding primer.

In the method according to the invention there may be applied to the at least partially painted strip or strip coated in a paint-like manner with a polymer-containing coating or to the at least partially painted strip section or strip section coated in a paint-like manner with a polymer-containing coating, in each case at least one paint coat, a mixture of or with polymers, colourant, adhesive and/or adhesive carrier.

In the method according to the invention the decontaminated or cleaned and optionally activated metal surface may be brought into contact with the liquid, solution or suspension for one of the anticorrosive coatings and at least one film, optionally also containing particles, may be formed on the metal surface, which film is subsequently dried and optionally in addition cured, wherein the dried and optionally also cured film may in each case have a coat thickness in the range from 0.01 to 100 μm, in particular a film with a layer thickness in the range from 5 up to 50 μm, particularly preferably in the range from 8 up to 30 μm. As particles there may be used pigments, in particular coloured pigments or white pigments, metal particles such as for example zinc particles, fillers of all types such as for example chalks, oxides such as aluminium oxide, talcum or silicates, carbon particles or nanoparticles.

In this connection at least one paint coat may be applied as base coat, or a paint-like polymer-containing coating may be applied as pretreatment primer, primer, primer to replace cathodic dipping paint, slip primer, reaction primer, welding primer and/or wash primer, optionally instead of a base coat. The overall paint structure may depending on the circumstances be up to 300 μm thick, generally up to 120 μm, often up to 90 μm, and occasionally only up to 70 μm thick, if more than one paint and/or paint-like coating is used.

In this connection at least one of the paint coats and/or paint-like polymer-containing coatings may be cured by heat and/or actinic radiation, in particular by UV radiation.

In the method according to the invention the coated strips or strip sections may be formed, painted, coated with polymers such as for example PVC, printed, bonded, hot-soldered, welded and/or joined to one another or to other parts by clinching or other joining techniques.

In the coating of metal strip the production flow sequence specified hereinafter may be adopted, in which the flow sequence for steel sheets to be galvanised is given by way of example. This production flow sequence may—possibly with the omission of the coating with a metal or with an alloy as in galvanising—also be applied to other metal substrates and employed in the same way.

TABLE 1
Production sequence variants in the coating of
steel sheet to be galvanised

| | |
|---|---|
| 1. | Electrolytic cleaning with a strongly alkaline |
| | cleaner in order to remove organic impurities such as |
| | for example grease and oil as well as other dirt |
| | completely from the surface. |
| 2. | Rinsing with water in a rinse cascade, the last |
| | zone using fully deionised water. |
| 3. | Only in the case of electrolytic galvanising: acid |
| | pickling: brief spraying with water acidified with |
| | sulfuric acid to a pH of 1 to 2. |
| 4. | Galvanising: hot-dip galvanising by dipping in a |
| | molten bath or electrolytic galvanising by dipping in a |
| | bath containing an aqueous zinc solution: coating with |
| | technically pure zinc, which may possibly contain |
| | certain impurities, in particular aluminium and lead |
| | (HDG); coating with an iron-rich or aluminium-rich zinc |
| | alloy such as Glavanneal ®, Galfan ® or Galvalume ®. |
| 5. | In electrolytic galvanising: after deposition of |
| | the galvanising layer, acid pickling to remove |
| | unevenesses in the galvanising layer. |
| 6. | In particular if phosphate layers are to be |
| | applied: coating with an activation solution, in |
| | particular based on titanium. |
| 7. | Optional application of a first anticorrosive |
| | coating, for example as a prephosphating coating. |
| 8. | Optional rinsing with water or possibly post-rinse |
| | solution; after the prephosphating, only water. |
| 9. | Optional application of a second anticorrosive |
| | coating, for example an alkaline Fe/Co oxide layer. |
| 10. | Optional rinsing with water. |
| 11. | Optional application of a third anticorrosive |
| | coating, for example based on hexafluoride. |
| 12. | Optional rinsing with water. |
| 13. | Optional application of a first paint-like coating. |
| 14. | Optional UV irradiation to crosslink the paint-like |
| | coating. |
| 15. | Optional heating to temperatures in the range from |
| | 50° to 160° C. to effect thermal crosslinking of the |
| | paint-like coating. |
| 16. | Optional application of a second paint-like |
| | coating, the so-called paint intermediate coat. |
| 17. | Optional UV irradiation to crosslink the second |
| | paint-like coating. |
| 18. | Optional heating to temperatures in the range from |
| | 50° to 160° C. to effect thermal crosslinking of the |
| | second paint-like coating. |
| 19. | Optional application of a first paint coat as |
| | filler or top coat, optionally modified with a content |
| | of nanoparticles. |
| 20. | Optional application of a second paint coat as |
| | filler or top coat, optionally modified with a content |
| | of nanoparticles. |
| 21. | Optional application of a third paint coat as top |
| | coat, optionally modified with a content of |
| | nanoparticles. |
| 22. | Optional heating to temperatures in the range from |
| | 50° to 160° C. to effect thermal crosslinking (curing) of |
| | the paint coat(s). |
| 23. | Optional UV irradiation to crosslink the last paint |
| | coat. |

In the following table the aforementioned process steps, for example for steel sheet to be galvanised, are allocated to the possible production lines and to the specific sequences and means and equipment that are possibly employed. The allocation of specific process steps to the production line is however only one of several possibilities in each case. Production line Zn=galvanising line. Production line CC=Coil Coating. Production line for vehicle body parts or vehicle body fabrication or corresponding fabrication line in aircraft production or aerospace industry=Kar. Z=number of process steps excluding all the possible intermediate steps that may possibly be required, such as for example pickling, cleaning, activating, rinsing or post-rinsing, and drying. These process variants apply for the most part in the same way also to other metallic materials, possibly without galvanising.

TABLES 2A-J
Variants in the allocation of process
steps and production lines in the case of steel sheet to
be galvanised, in which intermediate steps have been
omitted.
Variant A

| | | | Basis of the Most |
|---|---|---|---|
| Line | Z | Process Step | Important Components |
| Zn | 1 | Galvanising | Zinc, ZnFe, ZnAl |
| | 2 | Pretreatment, rinse or | Chromate, Fe/Co/Ni- |
| | | no rinse, optionally | oxide, free fluoride, |
| | | followed by post-rinse | complex fluoride, |
| | | | phosphate, phosphonate, |
| | | | rare earths, silane, |
| | | | silicate and/or polymer. |
| CC | 3 | Optionally mild alkaline | |
| | | cleaning | |
| | 4 | Chromium-containing or | Chromate, Fe/Co/Ni- |
| | | chromium-free | oxide, free fluoride, |
| | | pretreatment | complex fluoride, |
| | | | phosphate, phosphonate, |
| | | | rare earths, silane, |
| | | | silicate and/or polymer. |
| | 5 | Base coat | Coil-coating primer, |
| | | | slip primer or welding |
| | | | primer. UV and/or |
| | | | thermal curing. |
| CC | 6 | Optional paint | |
| or | | intermediate coat | |
| Kar | 7 | Toner | |
| | 8 | Clear lacquer, | |
| | | optionally two coats | |
| Kar | 9 | Cutting, pressing and/or | |
| | | punching | |
| | 10 | Optional (further) | |
| | | forming | |
| | 11 | Optional joining, for | |
| | | example by clinching, | |
| | | bonding | |
| | 12 | Optional clear lacquer | |

Variant B

| | | | Most Important |
|---|---|---|---|
| Line | Z | Process Step | Components |
| Zn | 1 | Galvanising | Zinc, ZnFe, ZnAl |
| | 2 | Pretreatment, rinse or | Chromate, Fe/Co/Ni-oxide, |
| | | no rinse, optionally | free fluoride, |
| | | followed by post-rinse | complex fluoride, |
| | | solution | phosphate, phosphonate, |
| | | | rare earths, silane, |
| | | | silicate and/or polymer. |
| CC | 3 | Optional mild alkaline | |
| | | cleaning | |
| | 4 | Base coat, optionally | Coil-coating, slip or |
| | | with pretreatment | welding primer. UV |
| | | properties | and/or thermally curing. |
| | | | Chromate, free fluoride, |
| | | | complex fluoride, |
| | | | phosphate, phosphonate, |
| | | | rare earths, silane, |
| | | | silicate, corrosion |
| | | | inhibitor, pigment, |
| | | | polymer and/or wax. |
| CC | 5 | Optional paint | |
| or | | intermediate coat | |
| Kar | 6 | Toner | |
| | 7 | Clear lacquer, | |
| | | optionally two coats | |
| Kar | 8 | Cutting, pressing and/or | |
| | | punching | |
| | 9 | Optional (further) | |
| | | forming | |
| | 10 | Optional joining, for | |
| | | example by clinching, | |
| | | bonding | |
| | 11 | Optional clear lacquer | |

Variant C

| | | | Most Important |
|---|---|---|---|
| Line | Z | Process Step | Components |
| Zn | 1 | Galvanising | Zinc, ZnFe, ZnAl |
| | 2 | Pretreatment, rinse or | Chromate, Fe/Co/Ni-oxide, |
| | | no rinse, optionally | free fluoride, |
| | | followed by post-rinse | complex fluoride, |
| | | solution | phosphate, phosphonate, |
| | | | rare earths, silane, |
| | | | silicate and/or polymer. |
| | 3 | Base coat, optionally | Coil-coating, slip or |
| | | with pretreatment | welding primer. UV |
| | | properties | and/or thermally curing. |
| | | | Chromate, free fluoride, |
| | | | complex fluoride, |
| | | | phosphate, phosphonate, |
| | | | rare earths, silane, |
| | | | silicate, corrosion |
| | | | inhibitor, pigment, |
| | | | polymer and/or wax. |
| Zn* | 4 | Optional paint | |
| | | intermediate coat | |
| CC | 5 | Toner | |
| or | 6 | Clear lacquer, | |
| Kar | | optionally two coats | |
| Kar | 7 | Cutting, pressing and/or | |
| | | punching | |
| | 8 | Optional (further) | |
| | | forming | |
| | 9 | Optional joining, for | |
| | | example by clinching, | |
| | | bonding | |
| | 10 | Optional clear lacquer | |

*possibly as an alternative to CC or Kar

Variant D

| | | | Most Important |
|---|---|---|---|
| Line | Z | Process Step | Components |
| Zn | 1 | Galvanising | Zinc, ZnFe, ZnAl |
| | 2 | Pretreatment, rinse or | Chromate, Fe/Co/Ni-oxide, |
| | | no rinse, optionally | free fluoride, |
| | | followed by post-rinse | complex fluoride, |
| | | solution | phosphate, phosphonate, |
| | | | rare earths, silane, |
| | | | silicate and/or polymer. |
| Zn | 3 | Base coat, optionally | Coil-coating, slip or |
| or | | with pretreatment | welding primer. UV |
| CC | | properties | and/or thermally curing. |
| | | | Chromate, free fluoride, |
| | | | complex fluoride, |
| | | | phosphate, phosphonate, |
| | | | rare earths, silane, |
| | | | silicate, corrosion |
| | | | inhibitor, pigment, |
| | | | polymer and/or wax. |
| CC | 4 | Optional paint | |
| or | | intermediate coat | |
| Kar | 5 | Toner | |
| | 6 | Clear lacquer, | |
| | | optionally two coats | |
| Kar | 7 | Cutting, pressing and/or | |
| | | punching | |
| | 8 | Optional (further) | |
| | | forming | |
| | 9 | Optional joining, for | |
| | | example by clinching, | |
| | | bonding | |
| | 10 | Optional clear lacquer | |

Variant E

| | | | Most Important |
|---|---|---|---|
| Line | Z | Process Step | Components |
| Zn | 1 | Galvanising | Zinc, ZnFe, ZnAl |
| | 2 | Base coat with | Coil-coating, slip or |
| | | pretreatment properties | welding primer. UV |
| | | | and/or thermally curing. |
| | | | Chromate, free fluoride, |
| | | | complex fluoride, |
| | | | phosphate, phosphonate, |
| | | | rare earths, silane, |
| | | | silicate, corrosion |
| | | | inhibitor, pigment, |
| | | | polymer and/or wax. |
| Zn* | 3 | Optional paint | |
| | | intermediate coat | |
| CC | 4 | Toner | |
| or | 5 | Clear lacquer, | |
| Kar | | optionally two coats | |
| | 6 | Cutting, pressing and/or | |
| | | punching | |
| Kar | 7 | Optional (further) | |
| | | forming | |
| | 8 | Optional joining, for | |
| | | example by clinching, | |
| | | bonding | |
| | 9 | Optional clear lacquer | |

*possibly as an alternative to CC or Kar

Variant F

| | | | Most Important |
|---|---|---|---|
| Line | Z | Process Step | Components |
| Zn | 1 | Galvanising | Zinc, ZnFe, ZnAl |
| | 2 | Base coat with | Coil-coating, slip or |
| | | pretreatment properties, | welding primer. UV |
| | | preferably UV curing | and/or thermally curing. |
| | | | Chromate, free fluoride, |
| | | | complex fluoride, |
| | | | phosphate, phosphonate, |
| | | | rare earths, silane, |
| | | | silicate, corrosion |
| | | | inhibitor, pigment, |
| | | | polymer and/or wax. |
| Zn* | 3 | Optional paint | |
| | | intermediate coat | |
| CC | 4 | Toner, preferably UV | |
| or | | curing | |
| Kar | 5 | Clear lacquer, | |
| | | preferably UV curing | |
| Kar | 6 | Cutting, pressing and/or | |
| | | punching | |
| | 7 | Optional (further) | |
| | | forming | |
| | 8 | Optional joining, for | |
| | | example by clinching, | |
| | | bonding | |
| | 9 | Optional clear lacquer, | |
| | | preferably UV curing | |

*possibly as an alternative to CC or Kar

Variant G

| | | | Most Important |
|---|---|---|---|
| Line | Z | Process Step | Components |
| Zn | 1 | Galvanising | Zinc, ZnFe, ZnAl |
| | 2 | Pretreatment, rinse or | Chromate, Fe/Co/Ni |
| | | no rinse, optionally | oxide, free fluoride, |
| | | followed by post-rinse | complex fluoride, |
| | | solution | phosphate, phosphonate, |
| | | | rare earths, silane, |
| | | | silicate and/or polymer. |
| | 3 | Base coat, optionally | Coil-coating, slip or |
| | | also with pretreatment | welding primer. UV |
| | | properties, preferably | and/or thermally curing. |
| | | UV curing | Chromate, free fluoride, |
| | | | complex fluoride, |
| | | | phosphate, phosphonate, |
| | | | rare earths, silane, |
| | | | silicate, corrosion |
| | | | inhibitor, pigment, |
| | | | polymer and/or wax. |
| Zn* | 4 | Optional paint | |
| | | intermediate coat | |
| Kar | 5 | Cutting, pressing and/or | |
| | | punching | |
| | 6 | Optional (further) | |
| | | forming | |
| | 7 | Optional joining, for | |
| | | example by clinching, | |
| | | bonding, welding | |
| | 8 | Toner, preferably UV | |
| | | curing | |
| | 9 | Clear lacquer, | |
| | | optionally two coats, | |
| | | preferably UV curing | |

*possibly as an alternative to CC or Kar

Variant H

| | | | Most Important |
|---|---|---|---|
| Line | Z | Process Step | Components |
| Zn | 1 | Galvanising | Zinc, ZnFe, ZnAl |
| | 2 | Base coat with | Coil-coating, slip or |
| | | pretreatment properties, | welding primer. UV |
| | | preferably UV curing | and/or thermally curing. |
| | | | Chromate, free fluoride, |
| | | | complex fluoride, |
| | | | phosphate, phosphonate, |
| | | | rare earths, silane, |
| | | | silicate, corrosion |
| | | | inhibitor, pigment, |
| | | | polymer and/or wax. |
| Zn* | 3 | Optional paint | |
| | | intermediate coat | |
| Kar | 4 | Cutting, pressing and/or | |
| | | punching | |
| | 5 | Optional (further) | |
| | | forming | |
| | 6 | Optional joining, for | |
| | | example by clinching, | |
| | | bonding, welding | |
| | 7 | Toner, preferably UV | |
| | | curing | |
| | 8 | Clear lacquer, | |
| | | optionally two coats, | |
| | | preferably UV curing | |

*possibly as an alternative to CC or Kar

Variant J

| | | | Most Important |
|---|---|---|---|
| Line | Z | Process Step | Components |
| Zn | 1 | Galvanising | Zinc, ZnFe, ZnAl |
| | 2 | Base coat with | Coil-coating, slip or |
| | | pretreatment properties | welding primer. UV |
| | | | and/or thermally curing. |
| | | | Chromate, free fluoride, |
| | | | complex fluoride, |
| | | | phosphate, phosphonate, |
| | | | rare earths, silane, |
| | | | silicate, corrosion |
| | | | inhibitor, pigment, |
| | | | polymer and/or wax. |
| CC* | 3 | Optional paint | |
| | | intermediate coat | |
| | 4 | Toner, possibly UV | |
| | | curing | |
| Kar | 5 | Cutting, pressing and/or | |
| | | punching | |
| | 6 | Optional (further) | |
| | | forming | |
| | 7 | Optional joining, for | |
| | | example by clinching, | |
| | | bonding, welding | |
| | 8 | Clear lacquer, possibly | |
| | | two coats, possibly UV | |
| | | curing | |

*could also apply to other production lines such as Zn or Kar

The following table lists the metal substrates or metal coatings on substrates that can be coated with at least one anticorrosive coating and/or with at least one paint-like coating, and the preferred composition of the said anticorrosive coating.

TABLE 3
Connection between the preferred chemical
basis of anticorrosive coatings or corresponding
pretreatment solutions and the metallic substrate or
metal coating on a substrate.

| Chemical Basis of | | | | | | |
|---|---|---|---|---|---|---|
| Individual | | | | | | Zn Alloy, |
| Anticorrosive Coatings | Al/Al | Mg | Iron/ | Stainless | | AlZn |
| and of their Baths | Alloy | Alloy | Steel | Steel | Zn | Alloy |
| Oxalate | • | • | • | ⊕ | • | • |
| 1. Oxalate, | • | • | • | ⊕ | • | • |
| 2. Chromate | | | | | | |
| 1. Oxalate, 2. Polymer | • | • | • | ⊕ | • | • |
| post-rinse solution | | | | | | |
| 1. Fe/Co oxide, | | • | | | ⊕ | ⊕ |
| 2. AlZrF₆ | | | | | | |
| Ti and/or Zr | ⊕ | X | ⊕ | X | ⊕ | ⊕ |
| hexafluoride | | | | | | |
| Ti and/or Zr | ⊕ | • | ⊕ | X | ⊕ | ⊕ |
| hexafluoride with SiO₂ | | | | | | |
| 1. Ti and/or Zr | ⊕ | X | ⊕ | • | ⊕ | ⊕ |
| hexafluoride, | | | | | | |
| 2. Silane(s) | | | | | | |
| 1. Ti and/or Zr | ⊕ | • | ⊕ | • | ⊕ | ⊕ |
| hexafluoride, | | | | | | |
| 2. Mn phosphate | | | | | | |
| 1. Ti and/or Zr | ⊕ | ⊕ | • | • | • | • |
| hexafluoride, | | | | | | |
| 2. Phosphonate(s) | | | | | | |
| 1. Ti and/or Zr | ⊕ | ⊕ | ⊕ | • | X | X |
| hexafluoride, | | | | | | |
| 2. Phosphonate(s), | | | | | | |
| 3. Silane(s) | | | | | | |
| Rare earth element(s) | ⊕ | • | | | | |
| as nitrate(s) | | | | | | |
| Rare earth element(s) | ⊕ | • | • | | • | • |
| with Bi, peroxide and | | | | | | |
| chloride | | | | | | |
| Al phosphate | X | • | X | X | X | X |
| Fe phosphate | X | • | X | X | X | X |
| Mn phosphate | ⊕ | • | ⊕ | • | ⊕ | ⊕ |
| Zn phosphate | ⊕ | • | ⊕ | • | ⊕ | ⊕ |
| ZnMn phosphate | ⊕ | • | ⊕ | • | ⊕ | ⊕ |
| MnZn phosphate | ⊕ | • | ⊕ | X | ⊕ | ⊕ |
| 1. Phosphate, | ⊕ | X | ⊕ | • | ⊕ | ⊕ |
| 2. Chromate post-rinse | | | | | | |
| solution | | | | | | |
| 1. Phosphate, | ⊕ | X | ⊕ | • | ⊕ | ⊕ |
| 2. Ti/ZrF₆ post-rinse | | | | | | |
| solution | | | | | | |
| 1. Phosphate, | ⊕ | • | ⊕ | • | ⊕ | ⊕ |
| 2. Polymer post-rinse | | | | | | |
| solution | | | | | | |
| Zn/Mn phosphate with | X | • | ⊕ | • | ⊕ | ⊕ |
| polymer and Ti/ZrF₆ | | | | | | |
| Zn/Mn phosphate with | X | • | ⊕ | • | ⊕ | ⊕ |
| polymer, Ti/ZrF₆ and | | | | | | |
| nanoparticles | | | | | | |
| Polymer | • | • | • | • | • | • |
| Polymer with lubricant | X | • | X | X | X | X |
| Polymer with lubricant | ⊕ | • | ⊕ | X | ⊕ | ⊕ |
| and nanoparticles | | | | | | |
| Polymer with | ⊕ | • | ⊕ | X | ⊕ | ⊕ |
| lubricant, corrosion | | | | | | |
| inhibitor and | | | | | | |
| nanoparticles | | | | | | |
| Polymer with | ⊕ | • | ⊕ | X | ⊕ | ⊕ |
| lubricant, complex | | | | | | |
| fluoride, corrosion | | | | | | |
| inhibitor and | | | | | | |
| nanoparticles | | | | | | |
| Polymer with | ⊕ | • | ⊕ | X | ⊕ | ⊕ |
| lubricant, complex | | | | | | |
| fluoride, corrosion | | | | | | |
| inhibitor, | | | | | | |
| nanoparticles and | | | | | | |
| phosphate | | | | | | |
| Phosphonate | ⊕ | X | | | | |
| Silane(s)/siloxane(s) | ⊕ | X | ⊕ | • | ⊕ | ⊕ |
| Silane with Ti/ZrF₆ | ⊕ | X | ⊕ | | ⊕ | ⊕ |

with phosphate contents: optionally with addition of nickel
The symbols have the following meanings:
⊕: very suitable;
X: suitable;
•: suitable only in certain cases.
1., 2. and 3. indicate various successive coatings.

The method according to the invention is particularly advantageous since in the short term at least some and in the medium term all chemical and paint technology process steps can be transferred from the automotive works to the steel works or aluminium/magnesium rolling mill. There these process steps can be carried out on high-speed strip lines, in particular in strip plants, thereby ensuring a much more uniform and environmentally friendly operation, saving time, chemicals, water, space, energy, costs and providing higher quality. The costs of the pretreated, painted and optionally formed parts are accordingly much less per finished square metre-of treated surface. Smaller amounts-of slurry are formed than in the production procedure hitherto employed, especially in the pretreatment and painting. In particular, the volumes of the respective baths are significantly smaller. A typical bath volume is now only 5 to 15 m³ compared to previous volumes of about 20 to 250 m³. While the pretreatment and painting currently normally proceed at a rate of 3000 to 5000 m²/hour in a large modern automobile works, a throughput of about 8000 to 30,000 m²/hour can be achieved on strip lines. The total time involved in the cleaning and pretreatment can be reduced from 20 to 40 minutes to 15 to 30 seconds. The coat weight of the pretreatment coating may, depending on circumstances, be reduced from 1.5 to 4 g/m² to about 0.01 to 2 g/m². The consumption of chemicals in the pretreatment can be reduced from 20 to 40 g/m² to 1 to 10 g/m². Now only 0 to 6 g/m² of slurry are produced per m² of coated surface, compared to 15 to 40 g/m² of slurry previously. The painting and stoving time can be reduced from 120 to 180 minutes, to 0.1 to 2 minutes, for every two paint coats. The paint consumption falls from 200 to 300 g/m² for three paint coats to 80 to 120 g/m² for two paint coats. The overall costs have been able to be reduced to roughly 5 to 20% of the current overall costs per m² of coated surface.

It was surprising that with a synthetic resin coating according to the invention an extremely high-grade chromium-free film could be produced despite a coat thickness of only ca. 0.2 μm, the film furthermore exhibiting an extremely good paint adhesion strength on the coating according to the invention. It was also surprising that the addition of finely particulate particles produced a significant improvement in the paint adhesion strength, since although an improvement in the corrosion resistance could be expected due to the incorporation of the inorganic particles, no improvement in the paint adhesion strength could be foreseen.

If paint or paint-like coatings are applied to the strip and not during the production of parts or car bodies, then the production costs of parts or bodies can be significantly reduced. Coating on a strip line, such as for example on a coil coating line, is therefore to be preferred to coating during production of the parts or bodies.

### EXAMPLES

The present invention is described in more detail hereinafter with the aid of examples of implementation.

A) Examples of the Paint-Like Coating According to the Invention

Hot-dip galvanised steel sheets (Z) and Galvalume®-coated steel sheets (AZ) were coated with the aqueous dispersion according to the invention of the examples according to the invention, after alkaline cleaning.

This dispersion was prepared by intensive mixing (dissolver) of the components listed in Table 4.

TABLE 4
Composition of the aqueous UV-curable
dispersions and results of the investigations on the
coated substrates. Content data in wt. %, corrosion data
in area %.

| | Example | | | |
|---|---|---|---|---|
| | 1 | 2 | 3 | 4 |
| | Coating on steel | | | |
| | Z | Z | AZ | AZ |
| Polyurethane dispersion A | 85.0 | — | — | — |
| Acrylic-polyurethane hybrid | — | 70.8 | 70.8 | 70.8 |
| Polyethylene-glycol-diacrylate | 1.6 | — | — | — |
| Polyurethane dispersion B | — | 8.0 | 8.0 | 8.0 |
| Styrene-acrylate copolymer | — | 6.0 | 6.0 | 6.0 |
| Polyethylene wax emulsion | 2.0 | 2.0 | 2.0 | 2.0 |
| Acid adduct of 4-oxo-4-p-tolyl | 1.0 | 1.0 | 1.0 | 1.0 |
| butyrate, 4-ethylmorpholine | | | | |
| Hydroxycyclohexyl phenyl ketone, | 0.9 | 0.9 | 0.9 | 0.9 |
| benzophenone | | | | |
| Polyether-modified | 0.2 | 0.2 | 0.2 | 0.2 |
| polydimethylsiloxane | | | | |
| Added fully deionised water | 9.3 | 11.2 | 11.2 | 11.2 |
| Total binder content | 31.35 | 30.58 | 30.58 | 30.58 |
| Total water content | 66 | 67 | 67 | 67 |
| Coat weight (g/m²) | 3.0 | 3.0 | 1.5 | 3.0 |
| Results of the KFW (vehicle) test | | | | |
| according to DIN 50017: | | | | |
| Area corrosion, 240 hours | 0% | <5% | <1% | <1% |
| Conical mandrel 3.2 to 38 mm, 240 | <5% | <5% | <5% | <5% |
| hours | | | | |
| Area corrosion, 1200 hours | <5% | <5% | <5% | <5% |
| Conical mandrel 3.2 to 38 mm, 1200 | <5% | <5% | <20% | <20% |
| hours | | | | |
| Results of the salt spray test | | | | |
| according to DIN 50021, 24 hours: | | | | |
| Area corrosion | 20% | 20% | <1% | <10% |
| Edge corrosions | 3 mm | 3 mm | <1 mm | <1 mm |
| Conical mandrel at 3.2 to 38 mm | 20% | 50% | 20% | 10% |

An aqueous UV-curing dispersion with a particle size of less than 100 nm, a solids content of 35 wt. % and a pH value of 7.5 was used as polyurethane dispersion A. An aqueous non-UV-curing dispersion with a solids content of 35 wt. % and a pH value of 8.0 was used as polyurethane dispersion B. The acrylic-polyurethane hybrid (copolymer) is an aqueous UV-curing dispersion with a solids content of 40 wt. % and a pH value of 7.0. The polyethylene-glycol-diacrylate is an aqueous UV-curing solution with a solids content of 100 wt. % and an acid value of 25. The styrene-acrylate copolymer is an aqueous dispersion with a solids content of 50 wt. % and a pH value of 8.0, which improves the adhesion to the substrate surface. The polyethylene wax emulsion has a solids content of 50 wt. %, a melting point in the range from 62° to 95° C., and a pH value of 9.5. A content of this emulsion significantly improves the lubricating and forming properties. The corrosion inhibitor, i.e. acid adduct of 4-oxo-4-p-tolyl butyrate and 4-ethylmorpholine, being a TPA-amine complex, improves the corrosion protection and at the same time the adhesion of the polymer coating to the substrate. The mixture of hydroxycyclohexyl phenyl ketone and benzophenone serves as photoinitiator for starting the polymerisation in the UV curing. The wetting agent polyether-modified polydimethylsiloxane improves the surface wettability and thus the adhesion to the substrate surface. An addition of fully deionised water serves for the adjustment of the solids content and viscosity.

Coatings were applied by roller at room temperature and dried, and had a coat thickness roughly in the range from about 1.2 to 3.5 μm. The coated substrates were dried at about 50° to 90° C. in a circulating air oven and were then irradiated under flow conditions with UV-C light from a mercury lamp with an output of 160 W/cm. An almost complete polymerisation occurred within two seconds.

The results of the condensate water test atmosphere according to DIN 50017 KFW over 240 hours show a satisfactory to good adhesion, which however can be improved still further by adding a higher content of corrosion inhibitor(s). The results of the salt spray test according to DIN 50021 over 24 hours are satisfactory for a chromium-free system but likewise can similarly be improved still further by adding a higher content of corrosion inhibitor(s). The results of the salt spray test have also not proved to be sufficiently representative here. In the mandrel bending test according to DIN ISO 6860 the test surface was not cracked.

It was surprising that the coatings according to the invention in prolonged use over 12 months in the outdoor weather test according to VDA 621-414 exhibited a susceptibility to corrosion on Galvalume® of only <1%, and on hot-dip galvanised steel the corroded surface was less than 20%. Accordingly the coating according to the invention with dispersions corresponding to Examples 1 to 4 surprisingly proved in the outdoor weather test to be equivalent to the chromium-free coatings on Galvalume®.

A further improvement in the corrosion prevention and adhesion can be achieved by increasing the content of corrosion inhibitors, for example by adding at least one corrosion inhibitor in a total amount of up to 15 wt. %, in particular as a mixture of several organic and/or inorganic corrosion inhibitors. Preferred corrosion inhibitors are TPA-amine complexes, silicic acid in the form of nanoparticles, and phosphates or carbonates based on titanium or zirconium.

Coatings that can be applied as a single very thin (1 to 4 μm) coat on the metal surface and that provide permanent protection have now been obtained with the dispersion according to the invention. Accordingly, the chromium-free method according to the invention is extremely cost-effective compared to other chromium-free coating methods, which normally require paint coat thicknesses in the range from 20 to 150 μm and in particular involve a multi-coat paint structure.

It has also been shown that the same chemical composition is a good basis for forming a paint-like coating by an addition of electrically conducting compounds or electrically conducting particles, which is extremely suitable as a welding primer. The proportion of conducting particles used for this purpose was 40 to 150 wt. % referred to the sum of the remaining substances, including water, calculated as 100%.

B) Examples Relating to Phosphating Before Coating with the Paint-Like Coating According to the Invention

Experimental Series with Low Zn and Mn Contents:

The examples were carried out using the substrates and process steps specified hereinafter.

The test sheets consisted of an aluminium alloy AlMgSi 1.2 mm thick, or of uncoated, continuously annealed car body steel (CRS) or of steel hot-dip galvanised (HDG) on both sides, or of an electrolytically galvanised steel (EG) with a total thickness of 0.7 mm. The area of the substrates was 400 cm² (measured over both surfaces).

a) The substrate surfaces were cleaned in a 2% solution of an alkaline cleaner for 5 minutes at 60° C. and thereby thoroughly degreased.

b) This was followed by rinsing with tap water for 0.5 minute at room temperature.

c) The surfaces were then activated by dipping in a titanium-containing activation agent for 0.5 minute at room temperature.

d) Next, the surfaces were phosphated for 3 minutes at 55° C. by dipping in the phosphating solution.

e) The surfaces were then rinsed, first with tap water and then with fully deionised water.

f) The coated substrates were then dried in a drying oven at 80° C. for 10 minutes.

g) Finally, the dry test sheets were coated with a cathodic dipping paint and coated with further coats of a paint structure conventionally used in the automotive industry for car bodies (coat structure and paints corresponding to “Moon Silver”, Daimler Chrysler).

The composition of the respective phosphating solution as well as the results of the tests are shown in Table 5.

TABLE 5
Composition of the phosphating solutions in
g/l or points of free acid (FA) or total acid (TA)

| | | | | | TiF₆ + | | | | HA | | |
|---|---|---|---|---|---|---|---|---|---|---|---|
| | Zn | Mn | Ni | Cu | ZrF₆ | PO₄ | NO₂ | NO₃ | etc. | FA | TA |
| B 5 | 3.2 | 0.5 | 1.0 | — | — | 18 | 0.1 | 3 | — | 1.8 | 32 |
| B 6 | 3.2 | 0.5 | 1.0 | — | 0.011 + 0.008 | 18 | — | 3 | 1.5 HA | 1.8 | 32 |
| B 7 | 2.5 | 2.0 | — | 0.030 | — | 18 | — | 3 | 1.5 HA | 1.8 | 32 |
| B 8 | 2.5 | 2.0 | 0.5 | — | — | 18 | — | 3 | 1.5 HA | 1.8 | 32 |
| B 9 | 2.5 | 2.0 | 1.0 | — | — | 18 | — | 3 | 1.5 HA | 1.8 | 32 |
| B 10 | 2.5 | 2.0 | 2.0 | — | — | 18 | — | 3 | 1.5 HA | 1.8 | 32 |
| B 11 | 2.5 | 2.0 | 1.0 | — | — | 18 | 0.1 | 3 | — | 1.8 | 32 |
| B 12 | 2.5 | 2.0 | 1.0 | — | 0.011 + 0.008 | 18 | 0.1 | 3 | — | 1.8 | 32 |
| B 13 | 2.5 | 2.0 | 1.0 | 0.030 | 0.011 + 0.008 | 18 | — | 3 | 1.5 HA | 1.8 | 32 |
| B 14 | 3.5 | 2.0 | 1.0 | — | — | 18 | — | 3 | 1.5 HA | 1.8 | 32 |
| B 15 | 3.5 | 2.0 | 1.0 | — | — | 18 | 0.1 | 3 | | 1.8 | 32 |
| B 16 | 3.5 | 2.0 | 1.0 | — | 0.011 + 0.008 | 18 | 0.1 | 3 | | 1.8 | 32 |
| B 17 | 3.5 | 2.0 | 1.0 | — | 0.02 | 18 | — | 3 | 1.5 HA | 1.8 | 32 |
| | | | | | TiF₆ | | | | | | |
| B 18 | 3.5 | 2.0 | 1.0 | — | 0.02 | 18 | — | 3 | 1.5 HA | 1.8 | 32 |
| | | | | | ZrF₆ | | | | | | |
| B 19 | 4.5 | 3.0 | 1.0 | — | — | 18 | — | 3 | 1.5 HA | 1.8 | 32 |
| B 20 | 4.5 | 3.0 | 1.0 | — | — | 18 | — | 3 | 1.5 HA | 1.8 | 32 |
| B 21 | 4.5 | 3.0 | 0.5 | — | — | 18 | — | 3 | 1.5 HA | 1.8 | 32 |
| B 22 | 4.5 | 3.0 | 1.5 | — | — | 18 | — | 3 | 1.5 HA | 1.8 | 32 |

In addition the baths contained a minor to small sodium content as well as a content of free fluoride, for the pretreatment of aluminium surfaces, in the range from 80 to 250 mg/l by addition of ammonium bifluoride. The total acid is given approximately.

Experimental Series with High Mn and Zn Contents:

Metal sheets of electrolytically galvanised steel strip and steel strip hot-dip galvanised in parallel were treated as follows:

Sheet dimensions: 105×190×0.7 mm

Cleaning with a spray jet in an alkaline cleaning bath was first of all performed, followed by rinsing briefly three times with water. After the rinse procedure the metal sheets underwent a preliminary treatment by dipping in a titanium phosphate-containing activation solution followed by squeezing off the liquid film and application according to the invention of the phosphating solution. The phosphating solution was applied by means of a roll coater. After the application of the phosphating solution the sheets were dried for 30 seconds at 180° C. in an oven (PMT 80° C). The resulting coat weight of the dried liquid film was 1.5 g/m².

The treatment sequence is briefly outlined hereinbelow;

| | |
|---|---|
| Cleaning: | with Gardoclean ® 338, 8 g/l, 60° C., 10 sec |
| | spraying |
| Rinsing: | with cold water, 10 sec dipping |
| Rinsing: | with cold water, 4 sec spraying |
| Rinsing: | with fully deionised water (= FDW), 5 sec |
| | dipping |
| Activation: | with Gardolene ®, V6513, 4 g/l, in FDW, 5 sec |
| | dipping |
| Squeezing-off: | by means of a squeezing roller |
| Roller application: | phosphating solution according to |
| | the invention (see Table 1) with a roll |
| | coater |
| Drying: | in an oven at 180° C., 30 sec, PMT = 80° C. |

TABLE 6
Composition and density of the phosphating
solutions according to the invention in g/l or
g/cm³

| | Example | | | | | | | | | |
|---|---|---|---|---|---|---|---|---|---|---|
| | B 23 | B 24 | B 25 | B 26 | B 27 | B 28 | B 29 | B 30 | B 31 | B 32 |
| P₂O₅ | 226 | 223 | 151 | 134 | 228 | 134 | 139 | 205 | 207 | 138 |
| (g/l) | | | | | | | | | | |
| Zn | 42.0 | 41.4 | 59.0 | 24.8 | 60.0 | 24.9 | 25.7 | 31.1 | 31.4 | 25.6 |
| (g/l) | | | | | | | | | | |
| Mn | 25.1 | 24.7 | 16.3 | 14.7 | 25.2 | 14.7 | 15.2 | 36.4 | 36.6 | 15.1 |
| (g/l) | | | | | | | | | | |
| Ni | 9.2 | 0 | 6.3 | 0 | 0 | 0 | 0 | 0 | 5.3 | 0 |
| (g/l) | | | | | | | | | | |
| Polymer | 0 | 0 | 0 | 9.0 | 0 | 18.1 | 58.5 | 0 | 0 | 0 |
| (g/l) | | | | | | | | | | |
| NO₃ | 0 | 0 | 63.3 | 0 | 0 | 0 | 0 | 0 | 0 | 0 |
| (g/l) | | | | | | | | | | |
| H₂0₂ | 0 | 0 | 0 | 0 | 0 | 0 | 0 | 0 | 0 | 50 |
| (g/l) | | | | | | | | | | |
| Density | 1.272 | 1.255 | 1.258 | 1.129 | 1.279 | 1.131 | 1.169 | 1.245 | 1.255 | 1.165 |
| (g/cm³) | | | | | | | | | | |
| S value | 0.21 | 0.31 | 0.25 | 0.32 | 0.14 | 0.32 | 0.32 | 0.21 | 0.15 | 0.32 |
| Ratio | 1:2.9 | 1:3.4 | 1:1.8 | 1:3.4 | 1:2.7 | 1:3.4 | 1:3.4 | 1:3.0 | 1:2.8 | 1:3.4 |
| cations: | | | | | | | | | | |
| P₂O₅ | | | | | | | | | | |
| | Example | | | | | | | | | |
| | B 33 | B 34 | B 35 | B 36 | B 37 | B 38 | B 39 | B 40 | B 41 | B 42 |
| P₂O₅ | 196 | 196 | 198 | 198 | 198 | 198 | 198 | 198 | 198 | 198 |
| (g/l) | | | | | | | | | | |
| Zn | 17.0 | 17.0 | 17.0 | 17.0 | 18.0 | 18.0 | 18.0 | 18.0 | 17.0 | 17.0 |
| (g/l) | | | | | | | | | | |
| Mn | 11.9 | 12.0 | 12.0 | 12.0 | 22.0 | 22.0 | 22.0 | 22.0 | 12.0 | 12.0 |
| (g/l) | | | | | | | | | | |
| Ni | 0 | 0 | 6.0 | 6.0 | 0 | 0 | 6.0 | 6.0 | 6.0 | 0 |
| (g/l) | | | | | | | | | | |
| Polymer | 1.0 | 0 | 1.0 | 0 | 1.0 | 0 | 1.0 | 0 | 1.0 | 1.0 |
| (g/l) | | | | | | | | | | |
| NO₃ | 0 | 0 | 0 | 0 | 0 | 0 | 0 | 0 | 0 | 0 |
| (g/l) | | | | | | | | | | |
| H₂O₂ | 0 | 35 | 0 | 35 | 0 | 35 | 0 | 35 | 35 | 35 |
| (g/l) | | | | | | | | | | |
| Density | 1.187 | 1.190 | 1.198 | 1.195 | 1.202 | 1.200 | 1.213 | 1.210 | 1.198 | 1.190 |
| (g/cm³) | | | | | | | | | | |
| S value | 0.65 | 0.65 | 0.57 | 0.57 | 0.52 | 0.52 | 0.45 | 0.45 | 0.57 | 0.65 |
| Ratio | 1:6.78 | 1:6.78 | 1:5.66 | 1:5.66 | 1:4.95 | 1:4.95 | 1:4.30 | 1:4.30 | 1:5.70 | 1:6.80 |
| cations: | | | | | | | | | | |
| P₂O₅ | | | | | | | | | | |
| | Example | | | | | | | | | |
| | B 43 | B 44 | B 45 | B 46 | B 47 | B 48 | B 49 | B 50 | B 51 | B 52 |
| P₂O₅ | 198 | 198 | 230 | 230 | 230 | 283 | 230 | 300 | 300 | 120 |
| (g/l) | | | | | | | | | | |
| Zn | 18.0 | 18.0 | 37.0 | 37.0 | 37.0 | 56.7 | 37.0 | 40.0 | 40.0 | 12 |
| (g/l) | | | | | | | | | | |
| Mn | 22.0 | 22.0 | 40.0 | 40.0 | 40.0 | 40.0 | 40.0 | 40.0 | 40.0 | 8 |
| (g/l) | | | | | | | | | | |
| Ni | 6.0 | 0 | 0 | 7.7 | 0 | 8.1 | 0 | 0 | 0 | 0 |
| (g/l) | | | | | | | | | | |
| Polymer | 1.0 | 1.0 | 0 | 0 | 0 | 0 | 8.0 | 0 | 13.3 | 0 |
| (g/l) | | | | | | | | | | |
| NO₃ | 0 | 0 | 0 | 0 | 0 | 0 | 0 | 0 | 0 | 0 |
| (g/l) | | | | | | | | | | |
| H₂O₂ | 35 | 35 | 60 | 80 | 80 | 80 | 60 | 60 | 60 | 25 |
| (g/l) | | | | | | | | | | |
| Density | 1.211 | 1.202 | 1.260 | 1.280 | 1.260 | 1.310 | 1.265 | 1.288 | 1.287 | 1.120 |
| (g/cm³) | | | | | | | | | | |
| S value | 0.45 | 0.52 | 0.18 | 0.12 | 0.18 | 0.13 | 0.18 | 0.28 | 0.28 | 0.61 |
| Ratio | 1:4.30 | 1:4.95 | 1:2.99 | 1:2.72 | 1:2.99 | 1:2.70 | 1:2.99 | 1:3.75 | 1:3.75 | 1:6.00 |
| cations: | | | | | | | | | | |
| P₂O₅ | | | | | | | | | | |
| | Example | | | | | | | | | |
| | B 53 | B 54 | B 55 | B 56 | B 57 | B 58 | B 59 | B 60 | B 61 | B 62 |
| P₂O₅ | 120 | 214 | 214 | 196.3 | 198 | 198 | 402 | 402 | 420 | 465 |
| (g/l) | | | | | | | | | | |
| Zn | 12 | 40.0 | 40.0 | 37.1 | 18.0 | 18.0 | 78.5 | 78.5 | 68.0 | 97.0 |
| (g/l) | | | | | | | | | | |
| Mn | 8 | 23.6 | 23.6 | 21.8 | 12.0 | 22.0 | 55.3 | 55.3 | 78.0 | 80.0 |
| (g/l) | | | | | | | | | | |
| Ni | 0 | 0 | 0 | 7.9 | 6.0 | 6.0 | 7.3 | 7.3 | 9.7 | 0 |
| (g/l) | | | | | | | | | | |
| Polymer | 3.0 | 0 | 13.3 | 0 | 0 | 0 | 2.0 | 0 | 0 | 0 |
| (g/l) | | | | | | | | | | |
| NO₃ | 0 | 0 | 0 | 0 | 0 | 0 | 0 | 0 | 0 | 0 |
| (g/l) | | | | | | | | | | |
| H₂O₂ | 25 | 50 | 50 | 43.5 | 0 | 0 | 60 | 0 | 80 | 80 |
| (g/l) | | | | | | | | | | |
| Density | 1.121 | 1.240 | 1.242 | 1.250 | 198 | 1.213 | 1.454 | 1.454 | 1.501 | 1.540 |
| (g/cm³) | | | | | | | | | | |
| S value | 0.61 | 0.31 | 0.31 | 0.20 | 0.57 | 0.45 | 0.12 | 0.12 | 0.11 | 0.12 |
| Ratio | 1:6.00 | 1:3.36 | 1:3.36 | 1:2.94 | 1:5.50 | 1:4.30 | 1:2.85 | 1:2.85 | 1:2.70 | 1:2.63 |
| cations: | | | | | | | | | | |
| P₂O₅ | | | | | | | | | | |

| | Example | | | |
|---|---|---|---|---|
| | B 63 | B 64 | B 65 | B 66 |
| P₂O₅ | 492 | 420 | 477 | 477 |
| (g/l) | | | | |
| Zn | 95.0 | 68.0 | 61.0 | 61.0 |
| (g/l) | | | | |
| Mn | 80.0 | 78.0 | 80.0 | 80.0 |
| (g/l) | | | | |
| Ni | 10.3 | 0 | 0 | 0 |
| (g/l) | | | | |
| Polymer | 0 | 0 | 0 | 13.3 |
| (g/l) | | | | |
| NO₃ | 0 | 0 | 0 | 0 |
| (g/l) | | | | |
| H₂O₂ | 80 | 60 | 60 | 60 |
| (g/l) | | | | |
| Density | 1.587 | 1.501 | 1.540 | 1.540 |
| (g/cm³) | | | | |
| S value | 0.10 | 0.11 | 0.20 | 0.20 |
| Ratio | 1:2.66 | 1:2.88 | 1:3.38 | 1:3.09 |
| cations: | | | | |
| P₂O₅ | | | | |

TABLE 7
Coat composition in mg/m² on electrolytically
galvanised steel strip (E.G.)

| | Example | | | | | | |
|---|---|---|---|---|---|---|---|
| | B 33 | B 34 | B 35 | B 36 | B 37 | B 38 | B 39 |
| Mn | 75.2 | 74.2 | 48.9 | 44.0 | 75.6 | 44.1 | 45.6 |
| Ni | 27.6 | 0.0 | 18.8 | 0.0 | 0.0 | 0.0 | 0.0 |
| Polymer | 0.0 | 0.0 | 0.0 | 27.1 | 0.0 | 54.3 | 175.4 |
| P₂O₅ | 679.2 | 670.2 | 451.8 | 402.4 | 683.0 | 403.1 | 416.6 |
| NO₃ | 0.0 | 0.0 | 189.8 | 0.0 | 0.0 | 0.0 | 0.0 |

The coat weight of the pre-phosphating coat was 0.4 to 1.8 g/m²; the zinc content varied with the acid value and was in the range-from 62 to 820 mg/m².

Experimental Series Based on Complex Fluoride, Polymer and Nanoparticles:

The specified concentrations and compositions relate to the treatment solution itself and not to optionally used batch solutions of higher concentration. All concentration data should be understood as solids fractions, i.e. the concentrations relate to the weight proportions of the active components, irrespective of whether the raw materials used were present in dilute form, for example as aqueous solutions. The surface treatment of the test sheets was always carried out in the same way and in particular comprised the following steps:

I. Alkaline cleaning in a spray process with Gardoclean S5160

II. Rinsing with water

III. Rinsing with fully deionised water

IV. Application of the treatment solutions according to the invention by means of a Chemcoater

V. Drying in a circulating air oven (PMT: 60°-80° C.)

VI. Coating of the pretreated surfaces with coil coating paint systems (primer and top coat).

### Example 67 According to the Invention:

Steel sheets made from commercially available cold-rolled steel strip were first of all degreased in an alkaline spray jet cleaner and then treated with the aqueous composition according to the invention. For this, a specific amount of the treatment solution was applied so that a wet film thickness of ca. 6 ml/m² was obtained. The treatment solution contained, in addition to water and fluoro complexes of titanium and zirconium, also water-soluble copolymers based on acrylate and an organic phosphorus-containing acid as well as an aqueous dispersion of inorganic particles in the form of pyrogenic silicic acid. The solution had the following composition:

1.6 g/l hexafluorozirconic acid,

0.8 g/l hexafluorotitanic acid,

2 g/l polyacrylic acid/vinylphosphonate copolymer,

2 g/l SiO₂ (as pyrogenic silicic acid),

1 g/l citric acid.

The silicic acid dispersion contained particles having a mean particle diameter measured by scanning electron microscopy in the range from about 20 to 50 nm. The constituents were mixed in the specified sequence and the pH value of the solution was then adjusted to 4.5 with a fluoride-containing ammonia solution. After application the solution was dried in a circulating air oven at ca. 70° C. PMT (Peak Metal Temperature). The steel sheets pretreated in this way were coated with a conventional commercial chromium-free coil coating paint system.

### Example 68 According to the Invention:

Steel sheets were treated as described in Example 67, but using a composition that contained only titanium as transition metal, and the inorganic particles in the form of an aqueous colloidal silica dispersion:

2 g/l hexafluorotitanic acid,

2 g/l polyacrylic acid/vinylphosphonate copolymer,

2 g/l SiO₂ (as colloidal silica dispersion)

0.5 g/l citric acid.

The silica dispersion contained particles having a mean particle diameter measured by scanning electron microscopy in the range from about 8 to 20 nm.

### Example 69 According to the Invention:

Steel sheets were treated as described in Example 67 but with a composition that additionally contained an hydrolysed alkoxysilane as coupling reagent:

2 g/l hexafluorozirconic acid,

2-g/l polyacrylic acid/vinylphosphonate copolymer,

2 g/l SiO₂ (as colloidal silica dispersion),

2.5 g/l aminopropyltrimethoxysilane (AMEO).

For the preparation of the bath the silane compound was first hydrolysed in an acetic acid solution by stirring for several hours, before adding the remaining constituents. The pH value was then adjusted to 5.

### Example 70 According to the Invention:

Starting with a water-insoluble polyethylene/acrylic acid copolymer, a 25% stable aqueous dispersion was obtained by adding an appropriate amount of ammonia solution at ca. 95° C. while stirring and cooling under reflux. Using the resultant dispersion a treatment solution was prepared having the following composition:

5 g/l polyethylene/acrylate copolymer (as aqueous dispersion),

2 g/l zirconium carbonate,

10 g/l SiO₂ (as pyrogenic silicic acid).

The pH value of the treatment solution was adjusted to 8.5. In this connection care should be taken to ensure that the pH value of the solution does not fall below 7.5 during the preparation, since this may lead to precipitation of the polymer or of the pyrogenic silicic acid. In addition it was ensured that the film was dried at a PMT of at least 80° C. As for the rest, the steel strip was treated as in Example 77.

### Example 71 According to the Invention:

Hot-dip galvanised steel sheets (HDG) with a zinc content of more than 95% in the galvanising layer were cleaned and degreased in the same way as the steel sheets in the examples described before, and underwent a surface treatment with a solution of the following composition:

2 g/l hexafluorotitanic acid,

1.8 g/l polyacrylic acid (molecular weight ca. 100,000),

5 g/l SiO₂ (as pyrogenic silicic acid).

The constituents were mixed in the above order in aqueous solution or dispersion.

### Example 72 According to the Invention:

Hot-dip galvanised steel sheets were treated similarly to Example 71, but with a composition that contained the inorganic particles in the form of a colloidal solution:

2 g/l hexafluorozirconic acid,

1.8 g/l polyacrylic acid (molecular weight ca. 100,000),

2 g/l SiO₂ (as colloidal silica dispersion).

The particles contained in the composition had a mean particle diameter in the range from 12 to 16 nm.

### Example 73 According to the Invention:

Hot-dip galvanised steel sheets were treated similarly to Example 72, but with a treatment solution whose content of inorganic particles was increased five-fold compared to the composition specified in Example 72:

2 g/l hexafluorozirconic acid,

1.8 g/l polyacrylic acid (molecular weight ca. 100,000),

10 g/l SiO₂ (as colloidal silica dispersion).

The increase in the particle concentration above the optimal values led to an impairment of, in particular, the adhesion properties of a subsequently applied further organic coating or paint coat.

### Example 74 According to the Invention:

Similar to Example 69 for steel surfaces, hot-dip galvanised steel sheets were treated with a composition that contained, in addition to fluorometallates, polymers and inorganic particles, also an hydrolysed silane in aqueous solution. The treatment solution consisted of the following constituents:

2 g/l hexafluorozirconic acid,

1.8 g/l polyacrylic acid (molecular weight ca. 100,000,

4 g/l SiO₂ (as colloidal silica dispersion),

2.5 g/l 3-glycidyloxypropyltrimethoxysilane (GLYMO).

For the preparation the silane component was first of all hydrolysed in aqueous solution and the remaining constituents were then added.

### Example 75 According to the Invention:

Corresponding to Example 70 according to the invention for steel surfaces, hot-dip galvanised steel sheets were coated with a treatment solution of the following composition, adjusted alkaline to pH 9:

5 g/l polyethylene/acrylate copolymer (as aqueous dispersion),

2 g/l zirconium carbonate,

4 g/l SiO₂ (as colloidal silica dispersion).

Here too the temperature of the metal sheet surface during the drying of the film was at least 80° C.

### Example 76 According to the Invention:

Hot-dip galvanised steel surfaces were treated corresponding to the preceding Example 75 with an alkaline composition of pH 9 that contained, in addition to the polymer dispersion and the Zr component, also an aqueous dispersion of TiO₂ particles with an average particle size of 5 nm and having the following composition:

5 g/l polyethylene/acrylate copolymer (as aqueous dispersion),

2 g/l zirconium carbonate,

4 g/l TiO₂ (as aqueous dispersion).

### Example 77 According to the Invention:

Corresponding to Example 76 according to the invention, is hot-dip galvanised steel surfaces were treated with a TiO₂-containing composition, which however in contrast to the preceding example had an acidic pH value of 3 and in addition to the titanium and zirconium compounds also contained aluminium ions.

3 g/l hexafluorozirconic acid,

2 g/l hexafluorotitanic acid,

0.3 g/l Al(OH)₃,

2 g/l polyacrylic acid (molecular weight ca. 100,000),

4 g/l TiO₂ (as aqueous dispersion).

The TiO₂-containing treatment solutions as a rule also have improved anticorrosion properties compared to the SiO₂-containing compositions, in particular on hot-dip galvanised surfaces. However, these compositions have a significantly reduced storage stability compared to the SiO₂-containing solutions.

Moreover it was found that an addition of manganese ions, for example added as metal in acidic solution or in the form of manganese carbonate, to the compositions listed in these examples surprisingly significantly improved the resistance to alkali. In this connection an addition of Mn ions in an amount ranging from 0.05 to 10 g/l proved particularly effective.

The compositions of the experimental baths listed in the examples are given in Table 8 by way of comparison.

TABLE 8
Survey of the composition of the examples

| | Zr, Ti, | c | | c | Inorganic | c | | c | |
|---|---|---|---|---|---|---|---|---|---|
| Ex. | Cr | [g/l] | Polymer | [g/l] | Particles | [g/l] | Additive | [g/l] | pH |
| B 67 | H₂ZrF₆, | 1.6 | Polyacryl*/ | 2 | Pyrogenic | 2 | Citric | 1 | 4.5 |
| | H₂TiF₆ | 0.8 | vinyl phosphonate | | SiO₂ | | acid | | |
| B 68 | H₂TiF₆ | 2 | Polyacryl/ | 2 | Colloidal | 2 | Citric | 0.5 | 4.5 |
| | | | vinyl phosphonate | | SiO₂ | | acid | | |
| B 69 | H₂ZrF₆ | 2 | Polyacryl/ | 2 | Colloidal | 2 | AMEO | 2.5 | 5 |
| | | | vinyl phosphonate | | SiO₂ | | | | |
| B 70 | H₂ZrF₆ | 2 | Ethylene/ | 5 | Pyrogenic | 10 | — | — | 8.5 |
| | | | acrylate | | SiO₂ | | | | |
| B 71 | H₂TiF₆ | 2 | Polyacryl | 1.8 | Pyrogenic | 5 | — | — | 2 |
| | | | | | SiO₂ | | | | |
| B 72 | H₂ZrF₆ | 2 | Polyacryl | 1.8 | Colloidal | 2 | — | — | 2 |
| | | | | | SiO₂ | | | | |
| B 73 | H₂ZrF₆ | 2 | Polyacryl | 1.8 | Colloidal | 10 | — | — | 2 |
| | | | | | SiO₂ | | | | |
| B 74 | H₂TrF₆ | 2 | Polyacryl | 1.8 | Colloidal | 4 | GLYMO | 2.5 | 5 |
| | | | | | SiO₂ | | | | |
| B 75 | Zr (CO₃)₂ | 2 | Ethylene/ | 5 | Colloidal | 4 | — | — | 9 |
| | | | acrylate | | SiO₂ | | | | |
| B 76 | Zr (CO₃)₂ | 2 | Ethylene/ | 5 | TiO₂ | 4 | — | — | 9 |
| | | | acrylate | | disprsn. | | | | |
| B 77 | H₂ZrF₆, | 3 | Polyacryl | 2 | TiO₂ | 4 | Al (OH)₃ | 0.3 | 3 |
| | H₂TiF₆ | 2 | | | disprsn. | | | | |

The adhesion test by means of the T bend was carried out according to the NCCA Norm, i.e. with a bending of T1 the gap between the bent halves of a metal sheet amounted to one sheet thickness (1 mm). After the bending the paint adhesion was tested by tear-off tests with an adhesive strip and the result was expressed as the percentage of the area from which paint had peeled off or become detached.

In the Erichsen adhesion test a grid section was first of all applied to the painted metal surface and an Erichsen depression of 8 mm was then made. Here too the paint adhesion was checked by tear-off tests with an adhesive strip and the result was expressed in the form of the percentage paint adhesion.

1. Method for coating a metal strip for the automotive, aircraft or aerospace industry, in which the strip or possibly the strip sections produced therefrom in the subsequent operation is/are first of all coated with at least one anticorrosive coating and then with at least one coat of a paint-like polymer-containing coating, in which the strip after the coating with at least one anticorrosive coating or after the coating with at least one coat of a paint-like coating is divided into strip sections, the coated strip sections then being formed, joined and/or coated with at least one (further) paint-like coating and/or paint coating, wherein the paint-like coating is produced by coating the surface with an aqueous dispersion that contains, in addition to water, at least one UV-crosslinkable water-soluble and/or water-dispersible resin, at least one wax as forming additive, at least one photoinitiator and at least one corrosion inhibitor, wherein the coating is dried and cured after it has been formed on the metal surface, and wherein a coating is formed that when cured has a coat thickness of up to 10 μm and that on a test surface subjected to a mandrel bending test according to DIN ISO 6860—but without cracking the test surface—using a mandrel of 3.2 mm to 38 mm diameter, does not exhibit signs of corrosion of more than 5% in an immediately following condensate water atmosphere test according to DIN 50017 KFW over 240 hours.

2. Method for coating a metal strip for the automotive, aircraft or aerospace industry, in which the strip is first of all coated with at least one coat of a paint-like polymer-containing coating without previously applying an anticorrosive coating, wherein the strip after the coating with at least one coat of a paint-like coating is divided into strip sections, wherein the coated strip sections are then formed, joined and/or coated with at least one (further) coat of a paint or a paint-like coating, wherein the paint-like coating is formed by coating the surface with an aqueous dispersion that contains, in addition to water, at least one UV-crosslinkable water-soluble and/or water-dispersible resin, at least one wax as forming additive, at least one photoinitiator and at least one corrosion inhibitor, wherein the coating is dried and cured after it has been formed on the metal surface, and wherein a coating is formed that, when cured, has a coat thickness of up to 10 μm and that on a test surface subjected to a mandrel bending test according to DIN ISO 6860—but without cracking the test surface—using a mandrel of 3.2 mm to 38 mm diameter, does not exhibit signs of corrosion of more than 5% in an immediately following condensate water atmosphere test according to DIN 50017 KFW over 240 hours.

3. Method according to claim 1 or 2, characterised in that the dispersion for forming a paint-like coating contains a resin or a mixture of resins selected from the group comprising derivatives based on acrylate, epoxide, phenol, polyethylene, polyurethane, polyester and styrene.

4. Method according to one of the preceding claims, characterised in that the dispersion for forming a paint-like coating contains at least one photoinitiator selected from the group comprising acetophenone, anthraquinone, benzoin, benzophenone, 1-benzoylcyclohexanol, phenyl ketone, thioxanthone and their derivatives and/or at least one organophosphorus compound, such as for example an acyl phosphine oxide.

5. Method according to one of the preceding claims, characterised in that the dispersion for forming a paint-like coating contains at least one corrosion inhibitor selected from the group comprising organometallic compounds, coated or non-coated inorganic pigments, aluminium phosphates, zinc phosphates, zinc salts of aminocarboxylates, 5-nitroisophthalic acid or cyanic acid, polymeric amino salts with fatty acids, metal salts of dodecylnaphthalenesulfonic acid, amino complexes and transition metal complexes of toluenepropionic acid, silanes and siloxanes, and 2-mercaptobenzothiazolylsuccinic acid or its amino salts.

6. Method according to one of the preceding claims, characterised in that the dispersion for forming a paint-like coating contains at least one forming additive.

7. Method according to one of the preceding claims, characterised in that the dispersion for forming a paint-like coating contains at least one wax as forming additive, in particular a wax selected from the group comprising paraffins, polyethylenes and polypropylenes, preferably an oxidised wax.

8. Method according to one of the preceding claims, characterised in that the wax used as lubricant in the dispersion for forming a paint-like coating has a melting point in the range from 40° to 160° C.

9. Method according to one of the preceding claims, characterised in that the dispersion for forming a paint-like coating contains a wetting agent, possibly based on polysiloxanes.

10. Method according to one of the preceding claims, characterised in that a finely divided powder or a dispersion containing fine-grained particles of for example a carbonate, oxide, silicate or sulfate is added as inorganic compound in particle form to the dispersion for forming a paint-like coating.

11. Method according to one of the preceding claims, characterised in that particles having a particle size distribution substantially in the range from 5 nm to 300 nm are added as inorganic compound in particle form to the dispersion for forming a paint-like coating.

12. Method according to one of the preceding claims, characterised in that particles based on aluminium oxide, barium sulfate, silicon dioxide, silicate, titanium oxide, zinc oxide and/or zirconium oxide are added as inorganic compound in particle form to the dispersion for forming a paint-like coating.

13. Method according to one of the preceding claims, characterised in that at least one water-miscible and/or water-soluble alcohol, a glycol ether, N-methylpyrrolidone and/or water is used as organic solvent for the organic polymers in the dispersion for forming a paint-like coating.

14. Method according to one of the preceding claims, characterised in that free fluoride and/or complex fluoride based on aluminium, boron, silicon, titanium, hafnium and/or zirconium is added to the dispersion for forming a paint-like coating.

15. Method according to one of the preceding claims, characterised in that the content of organic solvent in the dispersion for forming a paint-like coating is 0.1 to 5 wt. %.

16. Method according to one of the preceding claims, characterised in that the acid groups of the synthetic resins in the dispersion for forming a paint-like coating are stabilised with ammonia, with amines such as for example morpholine, dimethylethanolamine, diethylethanolamine or triethanolamine and/or with alkali metal hydroxides such as for example sodium hydroxide.

17. Method according to one of the preceding claims, characterised in that the aqueous composition for forming a paint-like coating contains at least one electrically conducting compound such as for example an electrically conducting polymer or electrically conducting inorganic particles, in particular those of less than 1 μm average size.

18. Method according to one of the preceding claims, characterised in that the aqueous composition for forming a paint-like coating optionally contains in each case at least one biocide, an antifoaming agent and/or a wetting agent.

19. Method according to one of the preceding claims, characterised in that the metal surface consists substantially of aluminium, iron, copper, magnesium, nickel, titanium, zinc and/or of an aluminium, iron, copper, magnesium, nickel, titanium and/or zinc-containing alloy, or of several of these metallic substances.

20. Method according to one of the preceding claims, characterised in that the metal surface is cleaned and/or galvanised, in particular freshly cleaned or freshly galvanised, wherein the galvanising may be carried out with zinc or a zinc-containing alloy.

21. Method according to one of the preceding claims, characterised in that the metal surface contains at least 80% aluminium and is cleaned, optionally pickled, optionally anodised and optionally passivated.

22. Method according to one of the preceding claims, characterised in that the metal surface is cleaned and optionally pretreated, in particular pretreated with a pretreatment solution based on fluoride, iron-cobalt and/or phosphate.

23. Method according to one of the preceding claims, characterised in that the metal surface is brought into contact with the dispersion for forming a paint-like coating by a roller application process, by wetting and squeezing, by flow coating or by dipping, and a wet film is formed.

24. Method according to one of the preceding claims, characterised in that the metal surface is wetted with the dispersion for forming a paint-like coating for a time ranging from 0.001 second up to 30 minutes, in the rapid coating of a strip in particular for a time ranging from 0.001 to 1 second, and in the coating of parts, for 10 seconds up to 30 minutes.

25. Method according to one of the preceding claims, characterised in that the metal surface during the coating with the dispersion for forming a paint-like coating has a temperature in the range from 5° to 60° C.

26. Method according to one of the preceding claims, characterised in that the dispersion for forming a paint-like coating has a temperature in the range from 5° to 60° C. during the coating.

27. Method according to one of the preceding claims, characterised in that the metal surface brought into contact with the dispersion for forming a paint-like coating is dried by a circulating air method, inductively and/or by radiation heat, whereby the volatile constituents of the dispersion are optionally removed by blowing.

28. Method according to one of the preceding claims, characterised in that the metal surface brought into contact with the dispersion for forming a paint-like coating is dried at an object temperature in the range from room temperature up to 180° C.

29. Method according to one of the preceding claims, characterised in that the metal surface brought into contact with the dispersion for forming a paint-like coating is, when it is largely or wholly free of water, irradiated with UV light preferably in the range from 180 to 500 nm, in order to initiate and/or carry out the polymerisation reaction.

30. Method according to one of the preceding claims, characterised in that the metal surface brought into contact with the dispersion for forming a paint-like coating is physically dried before, or before and during the UV curing.

31. Method according to one of the preceding claims, characterised in that with the dispersion for forming a paint-like coating an organic coating is formed which, after curing, has a coat weight in the range from 0.2 to 20 g/cm², in particular in the range from 1 to 5 g/cm².

32. Method according to one of the preceding claims, characterised in that the cured organic coating has a layer thickness of 0.1 to 10 μm.

33. Method according to one of the preceding claims, characterised in that the cured coat has a satisfactory handling strength, in particular a Persos pendulum hardness in the range from 30 to 500 sec.

34. Method according to one of the preceding claims, characterised in that the cured coating can be painted.

35. Method according to one of the preceding claims, characterised in that the coated metal parts, strips or strip sections are coated with at least one further organic coating, in particular a paint such as for example a top coat, an adhesive layer, an adhesive carrier, a film, a foam and/or a printed layer.

36. Method according to one of the preceding claims, characterised in that the substrate with the cured coating is optionally cut, formed, or bonded, welded, soldered, clinched, riveted or otherwise joined to another part.

37. Method according to one of the preceding claims, characterised in that the strip or the strip sections after the painting with a paint-like coating is/are optionally cut and the painted strip sections when cut are then formed and following this optionally joined to other shaped parts, in particular by flanging, clinching, bonding, welding and/or by another mechanical joining method.

38. Method according to one of the preceding claims, characterised in that at least two or three anticorrosive coatings are applied in succession, of which each of these two or three coatings is an anticorrosive coating selected from the group of coatings based on in each case iron-cobalt, nickel-cobalt, at least one fluoride, at least one complex fluoride, in particular tetrafluoride or hexafluoride, an organic hydroxy compound, a phosphate, a phosphonate, a polymer, a rare earth compound including compounds of lanthanum and yttrium, a silane/siloxane, a silicate, cations of aluminium, magnesium and/or at least one transition metal selected from the group comprising chromium, iron, hafnium, cobalt, manganese, molybdenum, nickel, titanium, tungsten and zirconium, or a coating based on nanoparticles, and optionally at least one further anticorrosive coating may also be applied.

39. Method according to one of the preceding claims, characterised in that the first anticorrosive coating is applied in a drying process and that the second anticorrosive coating is applied in a drying process or rinse process.

40. Method according to one of the preceding claims, characterised in that the first anticorrosive coating is applied in a rinse process and that the second anticorrosive coating is applied in a drying process or rinse process.

41. Method according to one of the preceding claims, characterised in that the second anticorrosive coating is applied in a post-rinse stage, in particular after the first anticorrosive coating was previously applied on a galvanising line.

42. Method according to one of the preceding claims, characterised in that the second anticorrosive coating is applied in a drying process, in particular after the first anticorrosive coating was previously applied on a galvanising line.

43. Method according to one of the preceding claims, characterised in that surfaces of aluminium, iron, cobalt, copper, magnesium, nickel, titanium, tin, zinc or aluminium, or iron, cobalt, copper, magnesium, nickel, titanium, tin and/or zinc-containing alloys are coated, and in particular electrolytically galvanised or hot-dip galvanised surfaces are coated.

44. Method according to one of the preceding claims, characterised in that coating is carried out with at least one liquid, solution or suspension largely or wholly free of chromium compounds before the coating with at least one paint and/or with at least one paint-like polymer-containing coat that optionally contains polymers, copolymers, cross polymers, oligomers, phosphonates, silanes and/or siloxanes.

45. Method according to one of the preceding claims, characterised in that no lead, cadmium, chromium, cobalt, copper and/or nickel is added to the liquid, solution or suspension for the first and/or second anticorrosive coating.

46. Method according to one of the preceding claims, characterised in that on account of the at least one anticorrosive coating—in contrast to the prior art at the priority date—at least one of the otherwise conventional pretreatment coats, paint coats and/or paint-like polymer-containing coats can be omitted, in particular a pretreatment coating and a paint coating.

47. Method according to one of the preceding claims, characterised in that the liquid, solution or suspension for at least one of the anticorrosive coatings and/or paint-like polymer-containing coatings contains, in addition to water, at least one organic film-forming agent with at least one water-soluble or water-dispersible polymer, copolymer, block copolymer, cross polymer, monomer, oligomer, their derivative(s), mixtures and/or mixed polymers.

48. Method according to one of the preceding claims, characterized in that the liquid, solution or suspension for at least one of the anticorrosive coatings and/or paint-like polymer-containing coatings contains, in addition to water, a total content of cations, tetrafluoro complexes and/or hexafluoro complexes of cations selected from the group comprising titanium, zirconium, hafnium, silicon, aluminium and boron and/or free or otherwise bound fluorine, of in particular 0.1 to 15 g/l referred to F₆, preferably 0.5 to 8 g/l F₆ or 0.1 to 1000 mg/l of free fluoride.

49. Method according to one of the preceding claims, characterised in that the liquid, solution or suspension for at least one of the anticorrosive coatings and/or paint-like polymer-containing coatings contains, in addition to water, a total content of free fluorine or fluorine not bonded to tetrafluoro complexes or hexafluoro complexes, of in particular 0.1 to 1000 mg/l calculated as free fluorine, preferably 0.5 to 200 mg/l and particularly preferably 1 to 150 mg/l.

50. Method according to one of the preceding claims, characterised in that the liquid, solution or suspension for at least one of the anticorrosive coatings, paint coats and/or paint-like polymer-containing coatings contains, in addition to water, at least one inorganic compound in particle form having a mean particle diameter measured in a scanning electron microscope in the range from 0.003 to 1 μm diameter, preferably in the range from 0.005 to 0.2 μm diameter, in particular based on Al₂O₃, BaSO₄, rare earth oxide(s), at least one other rare earth compound, SiO₂, silicate, TiO₂, Y₂O₃, Zn, ZnO and/or ZrO₂, preferably in an amount in the range from 0.1 to 80 g/l, particularly preferably in an amount in the range from 1 to 50 g/l, and most particularly preferably in an amount in the range from 2 to 30 g/l.

51. Method according to one of the preceding claims, characterised in that the liquid, solution or suspension for at least one of the anticorrosive coatings, paint coats and/or paint-like polymer-containing coatings contains at least one corrosion inhibitor selected from the group comprising phosphate compounds, phosphonate compounds, organic morpholine and thio compounds, aluminates, manganates, titanates and zirconates, preferably alkylmorpholine complexes, organic Al, Mn, Ti and/or Zr compounds, in particular of olefinically unsaturated carboxylic acids, for example ammonium salts of carboxylic acids such as chelated lactic acid titanate, triethanolamine titanate or zirconate, Zr-4-methyl-y-oxo-benzenebutanoic acid, aluminium-zirconium carboxylate, alkoxypropenol titanate or zirconate, titanium acetate and/or zirconium acetate and/or their derivatives, and Ti/Zr ammonium carbonate.

52. Method according to one of the preceding claims, characterised in that the liquid, solution or suspension for at least one of the anticorrosive coatings, paint coats and/or paint-like polymer-containing coatings contains at least one compound for the, in particular, slow neutralisation of comparatively acidic mixtures and/or for corrosion protection of unprotected or damaged parts of the metal surface, preferably based on carbonate or hydroxycarbonate or electrically conducting polymers, particularly preferably at least one basic compound with a layer structure such as for example Al-containing hydroxycarbonate hydrate (hydrotalcite).

53. Method according to one of the preceding claims, characterised in that the liquid, solution or suspension for at least one of the anticorrosive coatings, paint coats and/or paint-like polymer-containing coatings contains, in addition to water, at least one silane and/or siloxane calculated as silane, in particular in an amount in the range from 0.1 to 50 g/l, preferably in an amount in the range from 1 to 30 g/l.

54. Method according to one of the preceding claims, characterised in that the liquid, solution or suspension for at least one of the anticorrosive coatings, paint coats and/or paint-like polymer-containing coatings contains, in addition to water and/or at least one organic solvent, also at least one silane and/or siloxane calculated as silane, in particular in an amount in the range from 51 to 1300 g/l.

55. Method according to one of the preceding claims, characterised in that the liquid, solution or suspension for at least one of the anticorrosive coatings, paint coats and/or paint-like polymer-containing coatings contains, optionally in addition to water and/or at least one organic solvent, also at least one silane and/or siloxane calculated as silane, in particular in an amount in the range from 0.1 to 1600 g/l, preferably in an amount in the range from 100 to 1500 g/l.

56. Method according to one of the preceding claims, characterised in that the liquid, solution or suspension for at least one of the anticorrosive coatings, paint coats and/or paint-like polymer-containing coatings contains an inorganic film-forming agent in the form of a solution, dispersion, emulsion, microemulsion and/or suspension.

57. Method according to one of the preceding claims, characterised in that the liquid, solution or suspension for at least one of the anticorrosive coatings, paint coats and/or paint-like polymer-containing coatings contains as organic film-forming agent at least one synthetic resin, in particular at least one synthetic resin based on acrylate, ethylene, polyester, polyurethane, silicone polyester, epoxide, phenol, styrene, styrene/butadiene, urea/formaldehyde, their derivatives, copolymers, block copolymers, cross polymers, monomers, oligomers, polymers, mixtures and/or mixed polymers.

58. Method according to one of the preceding claims, characterised in that the liquid, solution or suspension for at least one of the anticorrosive coatings, paint coats and/or paint-like polymer-containing coatings contains as organic film-forming agent a synthetic resin mixture and/or mixed polymer that has a content of synthetic resin based on acrylate, ethylene, urea/formaldehyde, polyester, polyurethane, styrene and/or styrene/butadiene or their derivatives, copolymers, cross polymers, oligomers, polymers, mixtures and/or mixed polymers, from which an organic film is formed during or after the release of water and other volatile constituents.

59. Method according to one of the preceding claims, characterised in that the liquid, solution or suspension for at least one of the anticorrosive coatings, paint coats and/or paint-like polymer-containing coatings contains as organic film-forming agent synthetic resins and/or polymers, copolymers, block copolymers, cross polymers, monomers, oligomers, polymers, mixtures and/or mixed polymers or their derivatives based on acrylate, polyethyleneimine, polyurethane, polyvinyl alcohol, polyvinylphenol, polyvinylpyrrolidone and/or polyaspartic acid, in particular copolymers with a phosphorus-containing vinyl compound.

60. Method according to one of the preceding claims, characterised in that the liquid, solution or suspension for at least one of the anticorrosive coatings, paint coats and/or paint-like polymer-containing coatings contains synthetic resin whose acid number is in the range from 5 to 250.

61. Method according to one of the preceding claims, characterised in that the liquid, solution or suspension for at least one of the anticorrosive coatings, paint coats and/or paint-like polymer-containing coatings contains synthetic resins and/or polymers, copolymers, block copolymers, cross polymers, monomers, oligomers, polymers, mixtures and/or mixed polymers and/or their derivatives, whose molecular weights are in the region of 1000, preferably at least 5000 up to 500,000, and particularly preferably in the range from 20,000 to 200,000.

62. Method according to one of the preceding claims, characterised in that the liquid, solution or suspension for at least one of the anticorrosive coatings, paint coats and/or paint-like polymer-containing coatings contains synthetic resins and/or polymers, block copolymers, copolymers, cross polymers, monomers, oligomers, polymers, mixtures and/or mixed polymers or their derivatives, especially also based on pyrrolidone(s), in particular in an amount of 0.1 to 500 g/l, preferably 0.5 to 30 g/l or 80 to 250 g/l.

63. Method according to one of the preceding claims, characterised in that the liquid, solution or suspension for at least one of the anticorrosive coatings, paint coats and/or paint-like polymer-containing coatings contains an organic film-forming agent whose pH value in an aqueous preparation without addition of further compounds is in the range from 1 to 12.

64. Method according to one of the preceding claims, characterised in that the liquid, solution or suspension for at least one of the anticorrosive coatings, paint coats and/or paint-like polymer-containing coatings contains an organic film-forming agent that contains only water-solution synthetic resins and/or polymers, copolymers, block copolymers, cross polymers, monomers, oligomers, polymers, mixtures and/or mixed polymers or their derivatives, in particular those that are stable in solutions with pH values ≦5.

65. Method according to one of the preceding claims, characterised in that the liquid, solution or suspension for at least one of the anticorrosive coatings, paint coats and/or paint-like polymer-containing coatings contains an organic film-forming agent whose synthetic resins and/or polymers, copolymers, block copolymers, cross polymers, monomers, oligomers, polymers, mixtures and/or mixed polymers or their derivatives have carboxyl groups.

66. Method according to one of the preceding claims, characterised in that the liquid, solution or suspension for at least one of the anticorrosive coatings, paint coats and/or paint-like polymer-containing coatings contains an organic film-forming agent in which the acid groups of the synthetic resins and/or polymers, copolymers, block copolymers, cross polymers, monomers, oligomers, polymers, mixtures and/or mixed polymers or their derivatives are stabilised with ammonia, with amines such as for example morpholine, dimethylethanolamine, diethylethanolamine or triethanolamine and/or with alkali metal compounds such as for example sodium hydroxide.

67. Method according to one of the preceding claims, characterised in that the liquid, solution or suspension for at least one of the anticorrosive coatings, paint coats and/or paint-like polymer-containing coatings contains 0.1 to 200 g/l and preferably 0.3 to 50 g/l of the organic film-forming agent.

68. Method according to one of the preceding claims, characterised in that the liquid, solution or suspension for at least one of the anticorrosive coatings, paint coats and/or paint-like polymer-containing coatings contains 100 to 2000 g/l and preferably 300 to 1800 g/l of the organic film-forming agent.

69. Method according to one of the preceding claims, characterised in that the liquid, solution or suspension for at least one of the anticorrosive coatings, paint coats and/or paint-like polymer-containing coatings contains an amount of monomers, in particular in the region of at least 5 wt. %, preferably at least 20 wt. %, particularly preferably at least 40 wt. %.

70. Method according to one of the preceding claims, characterised in that the liquid, solution or suspension for at least one of the anticorrosive coatings, paint coats and/or paint-like polymer-containing coatings contains 0.1 to 50 g/l of cations, tetrafluoro complexes and/or hexafluoro complexes of cations selected from the group comprising titanium, zirconium, hafnium, silicon, aluminium and boron.

71. Method according to one of the preceding claims, characterised in that the liquid, solution or suspension for at least one of the anticorrosive coatings, paint coats and/or paint-like polymer-containing coatings contains at least one organometallic compound, in particular with a content of titanium and/or zirconium.

72. Method according to one of the preceding claims, characterised in that the liquid, solution or suspension for at least one of the anticorrosive coatings, paint coats and/or paint-like polymer-containing coatings contains at least one silane and/or siloxane, calculated as silane, in the aqueous composition, preferably in an amount from 0.2 to 40 g/l, particularly preferably in an amount of 0.5 to 10 g/l.

73. Method according to one of the preceding claims, characterised in that the liquid, solution or suspension for at least one of the anticorrosive coatings, paint coats and/or paint-like polymer-containing coatings contains at least one partially hydrolysed silane, at least one wholly hydrolysed silane and/or at least one siloxane.

74. Method according to one of the preceding claims, characterised in that the liquid, solution or suspension for at least one of the anticorrosive coatings, paint coats and/or paint-like polymer-containing coatings contains at least one partially hydrolysed and/or non-hydrolysed silane, in particular with a silane content of more than 100 g/l, particularly preferably with a silane content of more than 1000 g/l.

75. Method according to one of the preceding claims, characterised in that the liquid, solution or suspension for at least one of the anticorrosive coatings, paint coats and/or paint-like polymer-containing coatings contains at least one acyloxysilane, an alkylsilane, an aminosilane, a bis-silylsilane, an epoxysilane, a fluoroalkylsilane, a glycidoxysilane, an isocyanatosilane, a mercaptosilane, a (meth)acrylatosilane, a mono-silylsilane, a multi-silylsilane, a sulfur-containing silane, a ureidosilane, a vinylsilane and/or at least one corresponding siloxane.

76. Method according to one-of the preceding claims, characterised in that there is added to the liquid, solution or suspension for at least one of the anticorrosive coatings, paint coats and/or paint-like polymer-containing coatings, as inorganic compound in particle form, a finely divided powder, a dispersion or a suspension such as for example a carbonate, oxide, silicate or sulfate, in particular colloidal or amorphous particles.

77. Method according to one of the preceding claims, characterised in that there is added to the liquid, solution or suspension for at least one of the anticorrosive coatings, paint coats and/or paint-like polymer-containing coatings, as inorganic compound in particle form particles with a mean particle size in the range from 4 nm to 150 nm, in particular in the range from 10 to 120 nm.

78. Method according to one of the preceding claims, characterised in that there is added to the liquid, solution or suspension for at least one of the anticorrosive coatings, paint coats and/or paint-like polymer-containing coatings, as inorganic compound in particle form particles based on at least one compound of aluminium, barium, cerium, calcium, lanthanum, silicon, titanium, yttrium, zinc and/or zirconium.

79. Method according to one of the preceding claims, characterised in that the liquid, solution or suspension for at least one of the anticorrosive coatings, paint coats and/or paint-like polymer-containing coatings contains 0.1 to 300 g/l of the at least one inorganic compound in particle form.

80. Method according to one of the preceding claims, characterised in that the liquid, solution or suspension for at least one of the anticorrosive coatings, paint coats and/or paint-like polymer-containing coatings contains as organic solvent for the organic polymers at least one water-miscible and/or water-soluble alcohol, a glycol ether or a pyrrolidone such as for example N-methylpyrrolidone and/or water, and in the case where a solvent mixture is used contains in particular a mixture of at least one long-chain alcohol such as for example propylene glycol, an ester alcohol, a glycol ether and/or butanediol with water, preferably however only water without organic solvent.

81. Method according to one of the preceding claims, characterised in that the liquid, solution or suspension for at least one of the anticorrosive coatings, paint coats and/or paint-like polymer-containing coatings contains organic solvent in an amount in the range from 0.1 to 10 wt. %.

82. Method according to one of the preceding claims, characterised in that the liquid, solution or suspension for at least one of the anticorrosive coatings, paint coats and/or paint-like polymer-containing coatings contains as lubricant at least one wax selected from the group comprising paraffins, polyethylenes and polypropylenes, in particular an oxidised wax.

83. Method according to one of the preceding claims, characterised in that the liquid, solution or suspension for at least one of the anticorrosive coatings, paint coats and/or paint-like polymer-containing coatings contains as lubricant a wax whose melting point is in the range from 40° to 160° C. preferably in an amount of 0.1 to 100 g/l, particularly preferably 20 to 40 g/l or 0.1 to 10 g/l, and most particularly preferably 0.4 to 6 g/l, for example a crystalline polyethylene wax.

84. Method according to one of the preceding claims, characterised in that the liquid, solution or suspension for at least one of the anticorrosive coatings, paint coats and/or paint-like polymer-containing coatings contains at least one rare earth element compound, in particular at least one compound selected from the group comprising chloride, nitrate, sulfate, sulfamate as well as complexes with for example a halogen or with an aminocarboxylic acid, in particular complexes with EDTA, NTA or HEDTA, scandium, yttrium and lanthanum also being counted as rare earth elements.

85. Method according to one of the preceding claims, characterised in that the liquid, solution or suspension for at least one of the anticorrosive coatings, paint coats and/or paint-like polymer-containing coatings contains a rare earth element compound of and/or with cerium, in particular in a mixture with other rare earth elements, for example at least partially based on mixed metal.

86. Method according to one of the preceding claims, characterised in that the liquid, solution or suspension for at least one of the anticorrosive coatings, paint coats and/or paint-like polymer-containing coatings contains at least one oxidising agent, in particular a peroxide, at least one accelerator and/or at least one catalyst, preferably a compound or ions of Bi, Cu and/or Zn.

87. Method according to one of the preceding claims, characterised in that the liquid, solution or suspension for at least one of the anticorrosive coatings, paint coats and/or paint-like polymer-containing coatings contains at least one compound selected from the group comprising mono-silanes, bis-silanes and multi-silanes, in particular:
mono-silanes of the general formula SiXₘY₄₋ₘ
where m=1 to 3, preferably m=2 to 3,
where X=alkoxy, in particular methoxy, ethoxy and/or propoxy, and
where Y is a functional organic group selected from acyloxy, alkyl, acrylate, amino, epoxy, fluoroalkyl, glycidoxy, urea, isocyanate, mercapto, methacrylate and/or vinyl or their derivatives,
bis-silanes of the general formula Y₃₋ₚXₚ—Si-Z-Si—XₙY₃₋ₙ
where p and n=1 to 3 and are identical or different,
where X=alkoxy, in particular methoxy, ethoxy and/or propoxy,
where Y are functional organic groups selected from acyloxy, alkyl, acrylate, amino, epoxy, fluoroalkyl, glycidoxy, urea, isocyanate, mercapto, methacrylate and/or vinyl or their derivatives,
where Z is selected from the group comprising CₙH₂ₙ where n=2 to 20, in each case branched or unbranched; singly unsaturated alkyl chains of the general formula CₙH₂ₙ₋₂ where n=2 to 20, in each case branched or unbranched; doubly and/or multiply unsaturated alkyl compounds of the general formulae CₙH₂ₙ₋₄ where n=4 to 20, in each case branched or unbranched, CₙH₂ₙ₋₆ where n=6 to 20, in each case branched or unbranched, or CₙH₂ₙ₋₈ where n=8 to 20, in each case branched or unbranched; ketones, monoalkylamines, NH and sulfur S_{q} where q=1 to 20,
multi-silanes of the general formula Y₃₋ₚXₚ—Si-Z′-Si—XₙY₃₋ₙ
where p and n=1 to 3 and are identical or different,
where X=alkoxy, in particular methoxy, ethoxy and/or propoxy,
where Y are functional organic groups selected from acyloxy, alkyl, acrylate, amino, epoxy, fluoroalkyl, glycidoxy, urea, isocyanate, mercapto, methacrylate, mono/bis/multi-silyl and vinyl or their derivatives,
and where Z′=N—Si—XᵣY₃₋ᵣ where r=1 to 3, or sulfur S_{q} where q=1 to 20,
multi-silanes of the general formula Y₃₋ₚXₚ—Si-Z″-Si—XₙY₃₋ₙ where p and n=1 to 3 and are identical or different,
where X=alkoxy, in particular methoxy, ethoxy and/or propoxy,
where Y are functional organic groups selected from acyloxy, alkyl, acrylate, amino, epoxy, fluoroalkyl, glycidoxy, urea, isocyanate, mercapto, methacrylate, mono/bis/multi-silyl and vinyl or their derivatives,
and where Z″=—R—C[(SiXₛY₃₋ₛ)(SiXₜY₃₋ₜ)]—R′, or sulfur S_{q} where q=1 to 20,
where s and t=1 to 3 and are identical or different,
where R and R′ are identical or different and are selected from the group comprising CₙH₂, where n=2 to 20, in each case branched or unbranched; singly unsaturated alkyl chains of the general formula CₙH₂ₙ₋₂ where n=2 to 20, in each case branched or unbranched, doubly and/or multiply unsaturated alkyl compounds of the general formulae CₙH₂ₙ₋₄ where n=4 to 20, in each case branched or unbranched, CₙH₂ₙ₋₆ where n=6 to 20, in each case branched or unbranched, or CₙH₂ₙ₋₈ where n=8 to 20, in each case branched or unbranched; ketones, monoalkylamines and NH,
wherein the silanes may in each case be present hydrolysed, partially hydrolysed and/or non-hydrolysed in a solution, emulsion and/or suspension.

88. Method according to one of the preceding claims, characterised in that the liquid, solution or suspension for at least one of the anticorrosive coatings contains at least one compound of the type XYZ, X*Y*Z* and/or X*Y*Z*Y*X*,
wherein Y is an organic group with 2 to 50 C atoms,
wherein X and Z are identical or different and are an OH, SH, NH₂, NHR′, CN, CH═CH₂, OCN, CONHOH, COOR′, acrylic acid amide, epoxy, CH₂═CR″—COO, COOH, HSO₃, HSO₄, (OH)₂PO, (OH)₂PO₂, (OH)(OR′)PO, (OH)(OR′)PO₂, SiH₃ and/or an Si(OH)₃ group,
wherein R′ is an alkyl group with 1 to 4 C atoms,
wherein R″ is an H atom or an alkyl group with 1 to 4 C atoms, and
wherein the groups X and Z are in each case bonded to the group Y in the terminal position,
wherein Y* is an organic group with 1 to 30 C atoms,
wherein X* and Z* are identical or different and are an OH, SH, NH₂, NHR′, CN, CH═CH₂, OCN, CONHOH, COOR′, acrylic acid amide, epoxy, CH₂═CR″—COO, COOH, HSO₃, HSO₄, (OH)₂PO, (OH)₂PO₂, (OH)(OR′)PO, (OH)(OR′)PO₂, SiH₃, Si(OH)₃, >N—CH₂—PO(OH)₂, and/or an —N—[CH₂—PO(OH)₂]₂ group,
wherein R′ is an alkyl group with 1 to 4 C atoms, and
wherein R″ is an H atom or an alkyl group with 1 to 4 C atoms.

89. Method according to one of the preceding claims, characterised in that the liquid, solution or suspension for at least one of the anticorrosive coatings contains at least one compound of the type XYZ, wherein X is a COOH, HSO₃, HSO₄, (OH)₂PO, (OH)₂PO₂, (OH)(OR′)PO or (OH)(OR′)PO₂, group,
wherein Y is an organic group R that contains 2 to 50 C atoms, of which at least 60% of the C atoms are present as CH₂ groups,
wherein Z is an OH, SH, NH₂, NHR′, CN, CH═CH₂, OCN, epoxy, CH═CR″—COOH, acrylic acid amide, COOH, (OH)₂PO, (OH)₂PO₂, (OH)(OR′)PO or (OH)(OR′)PO₂ group,
wherein R′ is an alkyl group with 1 to 4 C atoms,
and wherein R″ is an H atom or an alkyl group with 1 to 4 C atoms, preferably in a total amount of 0.01 to 10 g/l, more preferably 0.05 to 5 g/l and most particularly preferably 0.08 to 2 g/l.

90. Method according to one of the preceding claims, characterised in that the compound of the type XYZ, X*Y*Z* and/or X*Y*Z*Y*X* is suitable for forming self-assembling molecules that are able to form a layer of these self-assembling molecules in particular on the metal surface, preferably a monomolecular layer.

91. Method according to one of the preceding claims, characterised in that the liquid, solution or suspension for at least one of the anticorrosive coatings contains at least one of the following compounds of the type XYZ, X*Y*Z* and/or X*Y*Z*Y*X*:
1-phosphonic acid-12-mercaptododecane,
1-phosphonic acid-12-(N-ethylamino)dodecane,
1-phosphonic acid-12-dodecene, p-xylylene-diphosphonic acid,
1,10-decanediphosphonic acid,
1,12-dodecanediphosphonic acid,
1,14-tetradecanediphosphonic acid,
1-phosphoric acid-12-hydroxydodecane,
1-phosphoric acid-12-(N-ethylamino)dodecane,
1-phosphoric acid-12-dodecene,
1-phosphoric acid-12-mercaptododecane,
1,10-decanediphosphoric acid,
1,12-dodecanediphosphoric acid,
1,14-tetradecanediphosphoric acid,
p,p′-biphenyldiphosphoric acid,
1-phosphoric acid-12-acryloyldodecane,
1,8-octanediphosphonic acid,
1,6-hexanediphosphonic acid,
1,4-butanediphosphonic acid,
1,8-octanediphosphoric acid,
1,6-hexanediphosphoric acid,
1,4-butanediphosphoric acid,
aminotrimethylenephosphonic acid,
ethylenediaminetetramethylenephosphonic acid,
hexamethylenediaminetetramethylenephosphonic acid,
diethylenetriaminepentamethylenephosphonic acid,
2-phosphonbutane-1,2,4-tricarboxylic acid.

92. Method according to one of the preceding claims, characterised in that at least one of the liquids, solutions or suspensions for at least one of the anticorrosive coatings and/or paint-like polymer-containing coatings contains phosphate and zinc and optionally also manganese, nickel and/or copper.

93. Method according to one of the preceding claims, characterised in that at least one of the liquids, solutions or suspensions for at least one of the anticorrosive coatings, paint coats and/or paint-like polymer-containing coatings contains 0.2 to less than 50 g/l of zinc ions, 0.5 to 45 g/l of manganese ions and 2 to 300 g/l of phosphate ions, calculated as P₂O₅.

94. Method according to one of the preceding claims, characterised in that at least one of the liquids, solutions or suspensions for at least one of the anticorrosive coatings, paint coats and/or paint-like polymer-containing coatings contains phosphate, preferably based on Zn or ZnMn, optionally with a content of nickel.

95. Method according to one of the preceding claims, characterised in that at least one of the liquids, solutions or suspensions for at least one of the anticorrosive coatings, paint coats and/or paint-like polymer-containing coatings contains phosphate, fluoride, tetrafluoride and/or hexafluoride.

96. Method according to one of the preceding claims, characterised in that at least one of the liquids, solutions or suspensions for at least one of the anticorrosive coatings, paint coats and/or paint-like polymer-containing coatings contains phosphonate, tetrafluoride and/or hexafluoride.

97. Method according to one of the preceding claims, characterised in that at least one of the liquids, solutions or suspensions for at least one of the anticorrosive coatings, paint coats and/or paint-like polymer-containing coatings contains an organic film-forming agent, fluoride, tetrafluoride, hexafluoride and/or at least one inorganic compound in particle form and optionally at least one silane.

98. Method according to one of the preceding claims, characterised in that at least one of the liquids, solutions or suspensions for at least one of the anticorrosive coatings, paint coats and/or paint-like polymer-containing coatings contains an additive selected from the group comprising organic binders, biocides, antifoaming agents, corrosion inhibitors, coupling agents, wetting agents, photoinitiators and polymerisation inhibitors.

99. Method according to one of the preceding claims, characterised in that at least one of the liquids, solutions or suspensions for at least one of the anticorrosive coatings, paint coats and/or paint-like polymer-containing coatings contains at least one filler and/or a pigment, in particular at least one electrically conducting pigment selected from the group comprising dyes, colour pigments, graphite, graphite-mica pigments, oxides such as iron oxides, phosphates, phosphides such as iron phosphides, carbon black and zinc.

100. Method according to one of the preceding claims, characterised in that an activating treatment is carried out before the application of an anticorrosive coating, paint coat or paint-like polymer-containing coating.

101. Method according to one of the preceding claims, characterised in that a post-rinse and/or passivation is carried out after the application of an anticorrosive coating, paint coat or paint-like polymer-containing coating.

102. Method according to one of the preceding claims, characterised in that at least one of the liquids, solutions or suspensions for at least one of the anticorrosive coatings, paint coats and/or paint-like polymer-containing coatings contains an organic film-forming agent that is cured, after application to the metal substrate, by heat and/or actinic radiation, in particular by an electron beam or by UV radiation and/or radiation in the visible spectrum.

103. Method according to one of the preceding claims, characterised in that at least one of the anticorrosive coatings, paint coats and/or paint-like polymer-containing coatings is only partially cured before the bonding, welding and/or forming, and is fully cured only after the bonding, welding and/or forming, wherein the first curing is carried out before the bonding, welding and/or forming, by actinic radiation, in particular by an electron beam or by UV radiation and/or radiation in the visible spectrum, and the second curing is carried out after the bonding, welding and/or forming, preferably thermally, in particular by radiation heat and/or hot air.

104. Method according to one of the preceding claims, characterised in that the liquid, solution or suspension for at least one of the anticorrosive coatings, paint coats and/or paint-like polymer-containing coatings has a pH value in the range from 0.5 to 12.

105. Method according to one of the preceding claims, characterised in that the liquid, solution or suspension for at least one of the anticorrosive coatings, paint coats and/or paint-like polymer-containing coatings is applied to the respective surface at a temperature in the range from 50 to 95° C., preferably in the range from 5° to 50° C.

106. Method according to one of the preceding claims, characterised in that the substrate and/or the respective surface is maintained at temperatures in the range from 5° to 120° C. during the application of the anticorrosive coating(s).

107. Method according to one of the preceding claims, characterised in that the coated metal surface is dried at a temperature in the range from 20° to 400° C. PMT (Peak Metal Temperature).

108. Method according to one of the preceding claims, characterised in that the coated strips are cut up or wound into a coil, optionally after cooling to a temperature in the range from 10° to 70° C.

109. Method according to one of the preceding claims, characterised in that the cut-up strips are coated in the edge region after the pressing, cutting and/or stamping with a temporary protective coating that is subsequently removed or with a permanent coating, for example with at least one coating based on dry lubricant, phosphate, hexafluoride, paint-like coating and/or paint.

110. Method according to one of the preceding claims, characterised in that the liquid, solution or suspension for at least one of the anticorrosive coatings, paint coats and/or paint-like polymer-containing coatings is applied by roller coating, flow coating, knife coating, spray coating, sprinkling, brushing or dipping and optionally by subsequent squeezing with a roller.

111. Method according to one of the preceding claims, characterised in that the coating applied in each case with the liquid, solution or suspension for at least one of the anticorrosive coatings, paint coats and/or paint-like polymer-containing coatings is adjusted to a coat weight in the range from 0.0005 mg/m² to 150 g/m², preferably in the range from 0.0008 mg/m² to 30 g/m², particularly preferably in the range from 0.001 mg/m² to 10 g/m², and especially in the range from 1 to 6 g/m².

112. Method according to one of the preceding claims, characterised in that in each case at least one paint coat or a paint-like, polymer-containing coating is applied to the partially or fully cured film, wherein the first paint coat or paint-like polymer-containing coating is a coating that may consist substantially of a primer, a thinly (i.e. in the range from 0.1 to 10 μm) applied organic polymer-containing material, a reaction primer, a shop primer or a wash primer.

113. Method according to one of the preceding claims, characterised in that in each case at least one paint coat or a mixture of or with polymers, colourants, adhesive and/or adhesive carrier is applied to the at least partially painted strip or strip coated in a paint-like manner with a polymer-containing coating, or to the at least partially painted strip section or strip section coated in a paint-like manner with a polymer-containing coating.

114. Method according to one of the preceding claims, characterised in that the uncontaminated or cleaned and optionally activated metal surface is brought into contact with the liquid, solution or suspension for one of the anticorrosive coatings and at least one film, optionally also containing particles, is formed on the metal surface, which film is subsequently dried and optionally is additionally cured, wherein the dried and optionally also cured film may in each case have a coat thickness in the range from 0.01 to 100 μm, in particular a film with a coat thickness in the range from 5 to 50 μm, particularly preferably in the range from 8 to 30 μm.

115. Method according to one of the preceding claims, characterised in that at least one paint coat is applied as base coat or a paint-like polymer-containing coating is applied as pretreatment primer, primer, primer to replace cathodic dipping paint, slip primer, reaction primer, welding primer, wash primer, clear lacquer and/or top coat, optionally instead of a base coat.

116. Method according to one of the preceding claims, characterised in that at least one of the paint coats and/or paint-like polymer-containing coatings is cured by heat and/or by actinic, in particular UV, radiation.

117. Method according to one of the preceding claims, characterised in that the coated strips or strip sections are formed, painted, coated with polymers such as for example PVC, printed, bonded, hot-soldered, welded and/or joined to one another or to other parts by clinching or other joining techniques.

118. Use of the products produced according to the method according to at least one of the preceding claims in the automobile industry, in particular in large-scale automobile manufacture, for the production of components or body parts or preassembled units in the automobile, aircraft or aerospace industry; as sheeting, cladding, lining, car bodies or body parts, as parts for vehicles, trailers, mobile homes or missiles, as coverings, profiled sections, moulded parts of complicated geometry, bumpers, and parts of or with at least one tube section and/or a profiled section.
